(19) United States
(12) Patent Application Publication
(10) Pub. No.: US 2014/0083931 A1
(43) Pub. Date: Mar. 27, 2014

(54) Anti-biofouling Membrane for Water-Treatment

(71) Applicant: CHUNG YUAN CHRISTIAN UNIVERSITY, Tao-Yuan (TW)

(72) Inventors: Yung Chang, Taipei City (TW); Nien-Jung Lin, Taipei City (TW); Hui-Shan Yang, Taipei City (TW); Yu-Ju Shih, Taipei City (TW); Sheng-Wen Hsiao, Taipei City (TW); Juin-Yih Lai, Taipei City (TW)

(73) Assignee: CHUNG YUAN CHRISTIAN UNIVERSITY, Tao-Yuan (TW)

(21) Appl. No.: 14/079,261

(22) Filed: Nov. 13, 2013

Related U.S. Application Data
(63) Continuation-in-part of application No. 13/442,017, filed on Apr. 9, 2012.

(30) Foreign Application Priority Data
Mar. 5, 2012 (TW) 101107369

(51) Int. Cl. B01D 71/28

(52) U.S. Cl. CPC B01D 71/28
USPC 210/500.34

(57) ABSTRACT

This invention discloses an anti-biofouling membrane for water-treatment. The anti-biofouling membrane for water-treatment comprises a substrate, and an anti-biofouling copolymer on the substrate. The anti-biofouling copolymer comprises a plurality of hydrophobic groups and a plurality of hydrophilic groups. The anti-biofouling copolymer can be stably coated on the surface of the substrate by the hydrophobic groups. And the hydrophilic groups can help the anti-biofouling membrane to present excellent anti-biofouling capability. Preferably, the anti-biofouling copolymer coated on the substrate will not decrease the permeability of the substrate. More preferably, the presented capability of the mentioned anti-biofouling membrane for water-treatment can achieve the commercial level filtering membrane.

### CROSS REFERENCE TO RELATED APPLICATIONS

This application is a Continuation In Part of applicant's earlier application Ser. No. 13/442,017, filed Apr. 9, 2012.

### BACKGROUND OF THE INVENTION

1. Field of the Invention

The present invention is generally related to an anti-biofouling membrane, and more particularly to an anti-biofouling membrane for water-treatment.

2. Description of the Prior Art

In recent years, water-treatment is more and more important. Even water occupies lots area of the world, people still work hard on purifying and recycling the used water or wastewater.

Water-treatment, including surface water-treatment and wastewater treatment, means purifying water by changing what contained in the water through artificial or natural process. In one case, after water-treatment, the water from natural environment can be purified and used on industrial application or in human life. In another case, the wastewater after processing water-treatment can be discharged into nature environment or recycled for used. Generally, the water-treatment can employ physical treatment and/or chemical treatment to purify water.

In physical treatment, filtering materials with different aperture sizes can be used to stop the impurities in the water by absorption or blocking for obtaining purer water. Physical treatment also can purify water through sedimentation, wherein the impurities with smaller density in the water will float and be scooped up from the water surface, and the impurities with larger density in the water will precipitate to the bottom. In chemical treatment, chemicals are used to gather the impurities in the water or transfer the impurities into more safe to human being. For example, alum is a well-known chemical for water-treatment. While adding alum into the target water, the impurities in the water will be gathered, and the gathered impurities with larger volume can be easily filtered out.

Filtration process is a very important part in water-treatment. In filtration process, it is the key to select suitable filtering material. A suitable filtering material must have good flow selectivity for blocking small particles and molecules. And, it is better that the selected filtering material also have good revivification, and the performance of the used filtering material can be revived by easily washing. With the development of membrane technology, employing suitable membrane as filtering material in a filtration process of water-treatment is a hot issue. A suitable filtering membrane must be with high thermal stability, chemical stability, and mechanical strength. A suitable filtering membrane also must present good anti-fouling ability to bio-molecules, such as cells and virus, for keeping the pores of the filtering membrane from jammed by bio-molecules. In order to having those abilities, excluding the property of the filtering membrane, performing some proper modification on the filtering membrane is necessary.

Membrane technology which is a potential and efficient process has the following advantages for water-treatment: 1. The water after membrane filtration presents excellent quality. 2. The usage of chemicals can be decreased. 3. The filtration equipment does not occupy large space. 4. No chemical sludge produced during membrane filtration. 5. Filtration processes can be automatically operation. 6. Water-treatment can be cost down by employing membrane filtration.

Preferably, membrane filtration is a simple physical operation without phase transfer or heating requirement, so that membrane filtration can save energy and can be used for the treatment of heat-sensitive material or chemical-sensitive material. Besides, with the improvement of the membrane manufacture technology and the higher and higher request of water-recovery efficiency and of water quality, it is more and more popular to using membrane on water treatment and wastewater recovery. In membrane filtration, the pore size of the membrane is used to approach solid-liquid isolation to remove the polluting impurities in the water, wherein the impurities can be suspension particles, bacteria, virus, organic matters, pathogen, salt, and so on. Microfiltration (MF), ultrafiltration (UF), nanofiltration (NF), forward osmosis (FO), and reverse osmosis (RO) are popular membrane filtration used in all kinds of water treatment, such as the treatment and recovery of tap-water, domestic wastewater, and industrial wastewater. MF and UF also can be used in the pre-treatment of seawater desalinization. Besides providing physical membrane filtration in water-treatment, membrane also can be combined with other system to provide different membrane process. For instance, extracting reagent or absorbing reagent can be added into a membrane to provide membrane contactor (MC) for retracting metal materials in wastewater. While combined with waste-heat to provide membrane distillation process, membrane can be used for processing desalination of seawater or high solute concentration wastewater. While the process of MF, UF, NF, FO or RO combined with biological treatment technology to provide membrane bioreactor (MBR), membrane can be used for wastewater treatment more efficiently and saving more occupied area of water-treatment.

The characteristics of membrane, such as material, membrane pore size, porosity, surface charge, roughness, and hydrophobic/hydrophilic, will affect the filtering performance of the membrane. Moreover, the characteristics of membrane are highly related with the rate of the membrane fouled with impurities. Different material membrane has different fouled issue caused by the difference in pore size, configuration, hydrophobic/hydrophilic property, and so on. Excluding selecting filtering membrane by the characteristics such as material, pore size, porosity, surface charge, roughness, the fouled issue of the membrane can be decreased by membrane modification. Generally, hydrophobic membrane will more easily provide hydrophobic interaction with impurities, and the filtration efficiency will be decreased by the fast fouled rate. Therefore, if modified the hydrophobic membrane as hydrophilic or having specific functional group on the surface of the membrane, it can theoretically decrease the fouled rate.

According to literatures, polymer blending method can keep the original configuration and structure of the membrane. But, during polymer blending, in order to prevent the precipitation of hydrophilic modified polymer, it is necessary to polymerize parts of the hydrophilic modified polymer with the hydrophobic polymer of the membrane for obtaining copolymer in the solution for producing membrane. So that the compatibility of the copolymer and the solution and the effect of the copolymer to membrane formation must be considered, and the parameter and condition for producing membrane must be tuned frequently for obtaining better membrane. Another well-known modification method is surface grafting. Surface grafting can provide high stability and high performance. However, surface grafting will change the membrane configuration, and not easily to be applied on industrial scale. Still another modification method is directly coating. Directly coating is a simpler and faster modification method, and can be applied on large area modification and industrial scale. But, the stability and long-term efficiency of the modified membrane must be considered.

In view of the above matter, developing a novel anti-biofouling membrane for water-treatment having the advantages of high stability, high anti-biofouling capability, easily renewed by simply water washing, being able to apply on large area modification and industrial scale is still an important task for the industry.

### SUMMARY OF THE INVENTION

In light of the above background, in order to fulfill the requirements of the industry, the present invention provides a novel anti-biofouling membrane for water-treatment having the advantages of easy manufacturing process, low manufacturing cost, high stability, high anti-fouling capability, compatible engineering process, and renewable through simple flushing.

One object of the present invention is to provide an anti-biofouling membrane for water-treatment by modifying a substrate with a plurality of hydrophobic groups and a plurality of hydrophilic groups to form an anti-biofouling membrane. The mentioned anti-biofouling membrane presents excellent stability and anti-fouling capability. Preferably, through simply flushing, the mentioned anti-biofouling membrane can be reused and provide filtering ability as good as an original unused membrane.

Another object of the present invention is to provide an anti-biofouling membrane for water-treatment by surface coating via an anti-biofouling copolymer onto a substrate. The mentioned substrate can be easily and quickly modified. Preferably, while designing suitable anti-biofouling copolymers and coating process, the obtained anti-biofouling membranes can present superior biofouling resistant performance than commercial available filtering membranes for water-treatment.

Accordingly, the present invention discloses an anti-biofouling membrane for water-treatment. The mentioned anti-biofouling membrane for water-treatment comprises a substrate, and an anti-biofouling copolymer on the substrate. The substrate can be a filtering membrane for water-treatment, such as MF, UF, NF FO, or RO. The anti-biofouling copolymer can comprise a plurality of first polymer segments with hydrophobic monomer groups and a plurality of second polymer segments with hydrophilic monomer groups. The anti-biofouling copolymer can be on the substrate by surface coating.

In one embodiment of this invention, the polymerized form of said anti-biofouling copolymer can be well-defined block copolymer, such as diblock copolymer, triblock copolymer, or other multi-block copolymer. The anti-biofouling copolymer with well-defined block copolymer form can be obtained through atom transfer radical polymerization (ATRP) by polymerizing a plurality of first polymer block segment with hydrophobic monomer groups and a plurality of second polymer block segment with hydrophilic monomer groups.

In one embodiment of this invention, the polymerized form of said anti-biofouling copolymer can be well-defined block copolymer, such as diblock copolymer, triblock copolymer, or other multi-block copolymer. The anti-biofouling copolymer with well-defined block copolymer form can be obtained through reversible addition-fragmentation chain transfer polymerization (RAFT) by polymerizing a plurality of first polymer block segment with hydrophobic monomer groups and a plurality of second polymer block segment with hydrophilic monomer groups.

In one embodiment of this invention, the polymerized form of said anti-biofouling copolymer can be random copolymer. The anti-biofouling copolymer with random copolymer form can be obtained through atom transfer radical polymerization (ATRP) by copolymerizing a plurality of first polymer random segments with hydrophobic monomer groups and a plurality of second polymer random segments with hydrophilic monomer groups.

In one embodiment of this invention, the polymerized form of said anti-biofouling copolymer can be random copolymer. The anti-biofouling copolymer with random copolymer form can be obtained through reversible addition-fragmentation chain transfer polymerization (RAFT) by copolymerizing a plurality of first polymer random segments with hydrophobic monomer groups and a plurality of second polymer random segments with hydrophilic monomer groups.

In one embodiment of this invention, the polymerized form of said anti-biofouling copolymer can be random copolymer. The anti-biofouling copolymer with random copolymer form can be obtained through thermal-induced free-radical polymerization (TFRP) by copolymerizing a plurality of first polymer random segments with hydrophobic monomer groups and a plurality of second polymer random segments with hydrophilic monomer groups.

In one embodiment of this invention, said anti-biofouling copolymer can be a diblock copolymer with a formula as PSₘ-b-PEGMAₙ. In the formula, m and n are respectively positive integer, and the ratio of m and n is about 0.26-8.05. The average molecular weight of the mentioned PSₘ-b-PEGMAₙ is about 0.5×10⁴ Da-5×10⁷ Da. In the mentioned formula PSₘ-b-PEGMAₙ, the “PS” as the first polymer block segment can be selected from one of the monomer groups consisting of the following: the styrene monomer group family, styrene monomer group substituted with C₁-C₁₈ linear alkyl monomer group, styrene monomer group substituted with C₁-C₁₈ branched alkyl monomer group, styrene monomer group substituted with C₁-C₁₈ acrylamide or methacrylamide monomer group. “PEGMA” in the mentioned PSₘ-b-PEGMAₙ as the second polymer block segment can be selected from one of the group consisting of the following: poly(ethylene glycol) methyl ether methacrylate or poly(ethylene glycol) methacrylate, poly(ethylene glycol) methyl ether acrylate, poly(ethylene glycol) acrylate.

In one embodiment of this invention, said anti-biofouling copolymer can be a random copolymer with a formula as PSₘ-r-PEGMAₙ. In the formula, m and n are respectively positive integer, and the ratio of m and n is about 0.26-8.05. The average molecular weight of the mentioned PSₘ-r-PEGMAₙ is about 0.5×10⁴ Da-5×10⁷ Da. In the mentioned formula PSₘ-r-PEGMAₙ, “PS” as the first polymer random segments can be selected from one of the group consisting of the following: the styrene monomer group family, styrene monomer group substituted with C₁-C₁₈ linear alkyl monomer group, styrene monomer group substituted with C₁-C₁₈ branched alkyl monomer group, styrene monomer group substituted with C₁-C₁₈ acrylamide or methacrylamide monomer group. “PEGMA” in the mentioned PSₘ-r-PEGMAₙ as the second polymer random segments can be selected from one of the group consisting of the following: poly(ethylene glycol) methyl ether methacrylate or poly(ethylene glycol) methacrylate, poly(ethylene glycol) methyl ether acrylate, poly(ethylene glycol) acrylate.

According to this invention, the mentioned “styrene monomer group family” is defined hereinafter as monomers with the structure of styrene or similar to styrene, and the monomer of the styrene monomer group family is selected from one of the group consisting of the following: styrene, Vinyl benzoate, α-Methylstyrene, Methylstyrene, 3-Methylstyrene, 4-Methylstyrene, 1,3-Diisopropenylbenzene, 2,4-Dimethylstyrene, 2,5-Dimethylstyrene, 2,4,6-Trimethylstyrene, 4-tert-Butylstyrene, 4-Vinylanisole, 4-Acetoxystyrene, 4-tert-Butoxystyrene, 3,4-Dimethoxystyrene, 2-Fluorostyrene, 3-Fluorostyrene, 4-Fluorostyrene, 2-(Trifluoromethyl)styrene, 3-(Trifluoromethyl)styrene, 4-(Trifluoromethyl)styrene, 2,6-Difluorostyrene, 2,3,4,4,6-Pentafluorostyrene, 2-Vinylnaphthalene, 4-Vinylbiphenyl, 9-Vinylanthracene, 4-Benzhydrylstyrene, 4-(Diphenylphosphino) styrene, 2-vinyl pyridine, 3-vinyl pyridine, 4-vinyl pyridine, N-Phenylacrylamide, N-Diphenylmethylacrylamide.

The mentioned C₁-C₁₈ linear alkyl monomer group is selected from one of the group consisting of the following: vinyl propionate, vinyl pivalate, vinyl neodecanoate, vinyl decanoate, vinyl stearate, methyl acrylate, ethyl acrylate, butyl acrylate, hexyl acrylate, lauryl acrylate, octadecyl acrylate, methyl methacrylate, ethyl methacrylate, butyl methacrylate, hexyl methacrylate, lauryl methacrylate, stearyl methacrylate, benzyl methacrylate.

The mentioned C₁-C₁₈ branched alkyl monomer group is selected from one of the group consisting of the following: tert-butyl acrylate, iso-butyl acrylate, 2-ethylhexyl acrylate, iso-octyl acrylate, 3,5,5-trimethylhexyl acrylate, iso-bornyl acrylate, tert-butyl methacrylate, iso-butyl methacrylate, 2-ethylhexyl methacrylate, cyclohexyl methacrylate.

The mentioned C₁-C₁₈ acrylate group and the C₁-C₁₈ methacrylate monomer group are respectively selected from one of the group consisting of the following: N-(3-methoxypropyl)acrylamide, N,N-dimethylacrylamide, N-isopropylacrylamide, N-isopropylmethacrylamide, N-(isobutoxymethyl)acrylamide, N-phenylacrylamide, N-diphenylmethylacrylamide.

### BRIEF DESCRIPTION OF THE DRAWINGS

FIG. 1A and FIG. 1B respectively present the coating density analysis diagram and the measured contact angle analysis diagram of PSₘ-b-PEGMAₙ according to this specification on the substrate;

FIG. 2 presents the SEM (scanning electron microscopy) images of surface morphology of non-coated PVDF (polyvinylidene fluoride) substrate and PVDF substrate coated with diblock copolymer PSₘ-b-PEGMAₙ according to this specification with different ratio of m and n;

FIG. 3 presents the measured contact angle analysis diagram of random copolymer PSₘ-r-PEGMAₙ according to this specification on the substrate;

FIG. 4 presents the SEM (scanning electron microscopy) images of surface morphology of non-coated PVDF (polyvinylidene fluoride) substrate and PVDF substrate coated with random copolymer PSₘ-r-PEGMAₙ according to this specification with different ratio of m and n;

FIG. 5 presents the test results on biofouling resistance to proteins of the anti-biofouling membrane with diblock copolymer PSₘ-b-PEGMAₙ according to this specification;

FIG. 6 presents the test results on biofouling resistance to proteins of the anti-biofouling membrane with random copolymer PSₘ-r-PEGMAₙ according to this specification;

FIG. 7 presents the test results on biofouling resistance to bacteria of the anti-biofouling membrane with diblock copolymer PSₘ-b-PEGMAₙ according to this specification;

FIG. 8A to FIG. 8C present the test results on biofouling resistance to bacteria of the anti-biofouling membrane with random copolymer PSₘ-r-PEGMAₙ according to this specification;

FIG. 9A and FIG. 9B respectively presents the test results on anchoring capability in DI water solution and anti-fouling stability of the anti-biofouling membrane with diblock copolymer PSₘ-b-PEGMAₙ according to this specification and the anti-biofouling membrane with random copolymer PSₘ-r-PEGMAₙ according to this specification;

FIG. 10A and FIG. 10B respectively presents the test results on anchoring capability in acidic and basic solutions and anti-fouling stability of the anti-biofouling membrane with diblock copolymer PSₘ-b-PEGMAₙ according to this specification and the anti-biofouling membrane with random copolymer PSₘ-r-PEGMAₙ according to this specification;

FIG. 11 illustrates a schematic diagram of MBR (membrane bioreactor) system for water-treatment of this specification;

FIG. 12A and FIG. 12B respectively presents the measured trans-membrane pressure (TMP) of non-coated PVDF substrate compared with the measured TMP of the PVDF substrate coated with the anti-biofouling copolymer PS₅₅-b-PEGMA₃₀ according to this specification and the anti-biofouling copolymer PS₂₄₁-r-PEGMA₇₆ according to this specification;

FIG. 12C and FIG. 12D respectively presents the measured trans-membrane pressure (TMP) of commercial available PVDF membrane compared with the measured TMP of the PVDF substrate coated with the anti-biofouling copolymer PS₅₅-b-PEGMA₃₀ according to this specification and the anti-biofouling copolymer PS₂₄₁-r-PEGMA₇₆ according to this specification; and

FIG. 13 presents the measured trans-membrane pressure (TMP) of Tokyo domestic wastewater filtration at room temperature of non-coated PVDF substrate compared with the measured TMP of the PVDF substrate coated with the anti-biofouling copolymer PS₅₅-b-PEGMA₃₀ according to this specification.

### DESCRIPTION OF THE PREFERRED EMBODIMENTS

What probed into the invention is an anti-biofouling membrane for water-treatment. Detailed descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater details in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

One preferred embodiment according to this specification discloses an anti-biofouling membrane for water-treatment. According to this embodiment, the mentioned anti-biofouling membrane for water-treatment comprises a substrate, and anti-biofouling copolymer on the substrate. The mentioned anti-biofouling copolymer can comprise a plurality of hydrophobic groups and a plurality of hydrophilic groups. In one preferred example of this embodiment, the anti-biofouling copolymer can be obtained through atom transfer radical polymerization (ATRP) by polymerizing a plurality of first polymer segments with hydrophobic monomer groups and a plurality of second polymer segments with hydrophilic monomer groups. In another preferred example of this embodiment, the anti-biofouling copolymer can be obtained through or reversible addition-fragmentation chain transfer polymerization (RAFT) by polymerizing a plurality of first polymer segments with hydrophobic monomer groups and a plurality of second polymer segments with hydrophilic monomer groups. In another preferred example of this embodiment, the anti-biofouling copolymer can be obtained through thermal-induced free-radical polymerization (TFRP) by polymerizing a plurality of first polymer segments with hydrophobic monomer groups and a plurality of second polymer segments with hydrophilic monomer groups.

The mentioned substrate can be a filtering membrane for water-treatment. In one preferred example of this embodiment, the mentioned substrate can be selected from one of the group consisting of the following: polyvinylidene fluoride (PVDF), polystyrene (PS), polyethylsulfone (PES), polypropylene (PP), polysulfone (PSf), polytetrafluoroethene (PTFE), polyamide (PA), polyimde (PI), Polyvinyl Chloride (PVC), carbon nano-tube (CNT), and inorganic ceramic membrane.

In one preferred example of this embodiment, the first polymer segments with hydrophobic monomer groups of the mentioned anti-biofouling copolymer can be polymerized from at least two monomers, and the mentioned monomer can be selected from one of the monomer group consisting of the following: styrene monomer group family, styrene monomer group substituted with C₁-C₁₈ linear alkyl monomer group, styrene monomer group substituted with C₁-C₁₈ branched alkyl monomer group, styrene monomer group substituted with C₁-C₁₈ acrylamide monomer group, and styrene monomer group substituted with C₁-C₁₈ methacrylamide monomer group. In one preferred example of this embodiment, the second polymer segments with hydrophilic monomer group of the mentioned anti-biofouling copolymer can be selected from one of the group consisting of the following: poly(ethylene glycol) methyl ether methacrylate, poly(ethylene glycol) methacrylate, poly(ethylene glycol) methyl ether acrylate, poly(ethylene glycol) acrylate.

In one preferred example of this embodiment, the ratio of the first polymer segments with hydrophobic monomer groups to the second polymer segments with hydrophilic monomer groups of the mentioned anti-biofouling copolymer is about 0.26-8.05. In one preferred example of this embodiment, the polymerized form of said anti-biofouling copolymer can be well-defined block copolymer. The mentioned well-defined block copolymer can be diblock copolymer, triblock copolymer, or other multi-block copolymer. In another preferred example of this embodiment, the polymerized form of said anti-biofouling copolymer can be random copolymer.

In one preferred example of this embodiment, when the mentioned anti-biofouling copolymer is well-defined block copolymer, the ratio of the first polymer block segments with hydrophobic monomer groups to the second polymer block segments with hydrophilic monomer groups of the anti-biofouling copolymer is about 0.26-6.11. In one preferred example, the anti-biofouling copolymer with well-defined block copolymer form can be obtained through atom transfer radical polymerization (ATRP). In another preferred example of this embodiment, the anti-biofouling copolymer with well-defined block copolymer form can be obtained through reversible addition-fragmentation chain transfer polymerization (RAFT).

In one preferred example of this embodiment, when the mentioned anti-biofouling copolymer is random copolymer, the molar ratio of the first polymer random segments with hydrophobic monomer groups to the second polymer random segments with hydrophilic monomer groups of the anti-biofouling copolymer is about 0.53-8.05. In one preferred example, the anti-biofouling copolymer with random copolymer form can be obtained through atom transfer radical polymerization (ATRP). In another preferred example, the anti-biofouling copolymer with random copolymer form can be obtained through reversible addition-fragmentation chain transfer polymerization (RAFT). In another preferred example, the anti-biofouling copolymer with random copolymer form can be obtained through free-radical polymerization (FRP).

In one preferred example of this embodiment, the average molecular weight of the mentioned anti-biofouling copolymer is about 0.5×10⁴ Da-5×10⁷ Da. Preferably, in one example of this embodiment, the average molecular weight of the mentioned anti-biofouling copolymer with diblock copolymer form is about 10 kDa-105 kDa. Preferably, in one example of this embodiment, the average molecular weight of the mentioned anti-biofouling copolymer with random copolymer form is about 20 kDa-135 kDa.

In one preferred example of this embodiment, the anti-biofouling copolymer can be self-assembled anchoring on the substrate by surface coating process.

Another preferred embodiment according to this specification discloses an anti-biofouling membrane for water-treatment. The mentioned anti-biofouling membrane for water-treatment comprises a substrate, and anti-biofouling copolymer on the substrate. The mentioned substrate can be a filtering membrane of water-treatment process. The substrate can be selected from one of the group consisting of the following: polyvinylidene fluoride (PVDF), polystyrene (PS), polyethylsulfone (PES), polypropylene (PP), polysulfone (PSf), polytetrafluoroethene (PTFE), polyamide (PA), polyimde (PI), Polyvinyl Chloride (PVC), carbon nano-tube (CNT), and inorganic ceramic membrane.

The mentioned anti-biofouling copolymer consists of a plurality of first polymer segments with hydrophobic monomer groups and a plurality of second polymer segments with hydrophilic monomer groups. In one preferred example of this embodiment, the first polymer segments with hydrophobic monomer group of the mentioned anti-biofouling copolymer can be polymerized from at least two monomers, and the mentioned monomer can be selected from one of the group consisting of the following: the styrene monomer group family, styrene monomer group substituted with C₁-C₁₈ linear alkyl monomer group, styrene monomer group substituted with C₁-C₁₈ branched alkyl monomer group, styrene substituted with C₁-C₁₈ acrylamide group, and styrene monomer group substituted with C₁-C₁₈ methacrylamide monomer group.

In one preferred example, the mentioned styrene monomer group family can be selected from one of the group consisting of the following: styrene, Vinyl benzoate, α-Methylstyrene, Methylstyrene, 3-Methylstyrene, 4-Methylstyrene, 1,3-Diisopropenylbenzene, 2,4-Dimethylstyrene, 2,5-Dimethylstyrene, 2,4,6-Trimethylstyrene, 4-tert-Butylstyrene, 4-Vinylanisole, 4-Acetoxystyrene, 4-tert-Butoxystyrene, 3,4-Dimethoxystyrene, 2-Fluorostyrene, 3-Fluorostyrene, 4-Fluorostyrene, 2-(Trifluoromethyl)styrene, 3-(Trifluoromethyl)styrene, 4-(Trifluoromethyl)styrene, 2,6-Difluorostyrene, 2,3,4,4,6-Pentafluorostyrene, 2-Vinylnaphthalene, 4-Vinylbiphenyl, 9-Vinylanthracene, 4-Benzhydrylstyrene, 4-(Diphenylphosphino) styrene, 2-vinyl pyridine, 3-vinyl pyridine, 4-vinyl pyridine, N-Phenylacrylamide, N-Diphenylmethylacrylamide.

In another preferred example, the mentioned C₁-C₁₈ linear alkyl monomer group can be selected from one of the group consisting of the following: vinyl propionate, vinyl pivalate, vinyl neodecanoate, vinyl decanoate, vinyl stearate, methyl acrylate, ethyl acrylate, butyl acrylate, hexyl acrylate, lauryl acrylate, octadecyl acrylate, methyl methacrylate, ethyl methacrylate, butyl methacrylate, hexyl methacrylate, lauryl methacrylate, stearyl methacrylate, benzyl methacrylate.

In still another preferred example, the mentioned C₁-C₁₈ branched alkyl monomer group can be selected from one of the group consisting of the following: tert-butyl acrylate, isobutyl acrylate, 2-ethylhexyl acrylate, iso-octyl acrylate, 3,5,5-trimethylhexyl acrylate, isobornyl acrylate, tert-butyl methacrylate, isobutyl methacrylate, 2-ethylhexyl methacrylate, cyclohexyl methacrylate.

In still another preferred example, the mentioned C₁-C₁₈ acrylamide monomer group and the C₁-C₁₈ methacrylamide monomer group can be respectively selected from one of the group consisting of the following: N-(3-methoxypropyl)acrylamide, N,N-dimethylacrylamide, N-isopropylacrylamide, N-isopropylmethacrylamide, N-(isobutoxymethyl)acrylamide, N-phenylacrylamide, N-diphenylmethylacrylamide.

The second polymer segments with hydrophilic monomer group of the mentioned anti-biofouling copolymer can be selected from one of the group consisting of the following: poly(ethylene glycol) methyl ether methacrylate, poly(ethylene glycol) methacrylate, poly(ethylene glycol) methyl ether acrylate, poly(ethylene glycol) acrylate. The average molecular weight of the second unit with hydrophilic group is about 300˜5000 Da. For example, when the second polymer segment with hydrophilic monomer group is poly(ethylene glycol) methyl ether methacrylate, the average molecular weight of the second polymer segment with hydrophilic monomer group can be 300˜5000 Da. In another example, when the second polymer segment with hydrophilic monomer group is poly(ethylene glycol) methacrylate, the average molecular weight of the second polymer segment with hydrophilic monomer group can be 360˜500 Da. In still another example, when the second polymer segment with hydrophilic monomer group is poly(ethylene glycol) methyl ether acrylate, the average molecular weight of the second polymer segment with hydrophilic monomer group can be 480˜5000 Da. In still another example, when the second polymer segment with hydrophilic monomer group is poly(ethylene glycol) acrylate, the average molecular weight of the second polymer segment with hydrophilic monomer group can be about 375 Da.

According to this embodiment, the polymerized form of the mentioned anti-biofouling copolymer can be well-defined block copolymer, or random copolymer. The mentioned well-defined block copolymer can be diblock copolymer, triblock copolymer, or other multi-block copolymer. In one preferred example of this embodiment, when the well-defined block copolymer is diblock copolymer, the diblock copolymer can be presents as PSₘ-b-PEGMAₙ, and the random copolymer can be presents as PSₘ-r-PEGMAₙ. In the above formula, “PS” as the first polymer segment can be polymerized from at least two monomers, and the mentioned monomer can be selected from the group consisted of the following: the styrene monomer group family, styrene monomer group substituted with C₁-C₁₈ linear alkyl monomer group, styrene monomer group substituted with C₁-C₁₈ branched alkyl monomer group, and styrene monomer group substituted with C₁-C₁₈ acrylamide monomer group, and styrene monomer group substituted with C₁-C₁₈ methacrylamide monomer group. In the above formula, “PEGMA” as the second polymer segment can represent as one of the group consisted of the following: poly(ethylene glycol) methyl ether methacrylate, poly(ethylene glycol) methacrylate, poly(ethylene glycol) methyl ether acrylate, poly(ethylene glycol) acrylate. m and n in the formula respectively represents positive integer. In one preferred example of this embodiment, the ratio of m and n is about 0.26-8.05. The average molecular weight of the mentioned anti-biofouling copolymer is about 10⁴ Da-5×10⁷ Da.

In one preferred example of this embodiment, when the mentioned anti-biofouling copolymer is well-defined block copolymer, the ratio of the first polymer block segments with hydrophobic monomer groups to the second polymer block segments with hydrophilic monomer groups of the anti-biofouling copolymer is about 0.26-6.11. In another preferred example of this embodiment, when the mentioned anti-biofouling copolymer is random copolymer, the ratio of the first polymer random segments with hydrophobic monomer groups to the second polymer random segments with hydrophilic monomer groups of the anti-biofouling copolymer is about 0.53-8.05.

In one preferred example of this embodiment, the anti-biofouling copolymer with well-defined block copolymer form, such as diblock copolymer, can be obtained through atom transfer radical polymerization (ATRP) by polymerizing a plurality of first polymer block segments with hydrophobic monomer groups and a plurality of second polymer block segments with hydrophilic monomer groups. For instance, the first polymer block segments with hydrophobic monomer groups can be polymerized from at least two monomers in the condition with catalyst and radical initiator firstly. And then the first polymer segments with hydrophobic monomer groups, such as polystyrene, subsequently react with the second polymer block segments with hydrophilic monomer groups, such as PEGMA monomers, to produce the mentioned PSₘ-b-PEGMAₙ.

In one preferred example of this embodiment, the anti-biofouling copolymer with well-defined block copolymer form, such as diblock copolymer, can be obtained through reversible addition-fragmentation chain transfer polymerization (RAFT) by polymerizing a plurality of first polymer block segments with hydrophobic monomer groups and a plurality of second polymer block segments with hydrophilic monomer groups. For instance, the first polymer block segments with hydrophobic monomer groups can be polymerized from at least two monomers of the first polymer block segments in the condition with catalyst and first RAFT reagent to form the first polymer block segments-first RAFT reagent. And, the second polymer block segments with hydrophilic monomer groups can react with second RAFT reagent to form the second polymer block segments-second RAFT reagent. Subsequently, the first polymer block segments-first RAFT reagent, such as polystyrene-first RAFT reagent, can react with the second polymer block segments-second RAFT reagent, such as PEGMA-second RAFT reagent, to produce the mentioned PSₘ-b-PEGMAₙ.

In another preferred example of this embodiment, the anti-biofouling copolymer with random copolymer form can be obtained through thermal-induced free-radical polymerization (TFRP) by polymerizing the monomers of the first polymer random segments with hydrophobic monomer groups and a plurality of second polymer random segments with hydrophilic monomer groups. For instance, the monomer of the first polymer random segments with hydrophobic monomer groups, such as styrene, can react with the second polymer random segments with hydrophilic monomer groups, such as PEGMA monomers (poly(ethylene glycol) methyl ether methacrylate), in the condition with radical initiator to obtain the anti-biofouling copolymer as PSₘ-r-PEGMAₙ.

In still another preferred example of this embodiment, the anti-biofouling copolymer with random copolymer form can be obtained through atom transfer radical polymerization (ATRP) by polymerizing a plurality of the monomer of the first polymer random segments with hydrophobic monomer groups and a plurality of second polymer random segments with hydrophilic monomer groups. For instance, in the condition with catalyst and radical initiator, the monomer of the first polymer random segments with hydrophobic monomer groups, such as styrene, can react with the second polymer random segments with hydrophilic monomer groups, such as PEGMA monomers, to obtain the anti-biofouling copolymer as PSₘ-r-PEGMAₙ.

In still another preferred example of this embodiment, the anti-biofouling copolymer with random copolymer form can be obtained through reversible addition-fragmentation chain transfer polymerization (RAFT) by polymerizing a plurality of the monomer of the first polymer random segments with hydrophobic monomer groups and a plurality of second polymer random segments with hydrophilic monomer groups. For instance, in the condition with catalyst and RAFT reagent, the monomer of the first polymer random segments with hydrophobic monomer groups, such as styrene, can react with the second polymer random segments with hydrophilic monomer groups, such as PEGMA monomers, to obtain the anti-biofouling copolymer as PSₘ-r-PEGMAₙ.

In one preferred example of this embodiment, the average molecular weight of the mentioned anti-biofouling copolymer with diblock copolymer form is about 10 kDa-105 kDa. In one preferred example of this embodiment, the average molecular weight of the mentioned anti-biofouling copolymer with random copolymer form is about 20 kDa-135 kDa.

According to the embodiment, the inventors find that the ratio of the chain length of the first polymer segments with hydrophobic monomer groups and the chain length of the second polymer segments with hydrophilic monomer groups, consisted of the second polymer segments, can be controlled by the amount of the first polymer segments with hydrophobic monomer groups in the ATRP reaction.

Comparing with ATRP, the anti-biofouling copolymer obtained from FRP is a random arranged polymer, that is, the arrangement of the first polymer segments with hydrophobic monomer groups and the second polymer segments with hydrophilic monomer groups of the anti-biofouling copolymer is random. The inventors of this specification find that the ratio of the first polymer segments with hydrophobic monomer groups and the second polymer segments with hydrophilic monomer groups in the anti-biofouling copolymer can be controlled by the amount of the first polymer segments with hydrophobic monomer groups and the second polymer segments with hydrophilic monomer groups during the FRP reaction. The inventors also find that while the ratio of the first polymer segments with hydrophobic monomer groups and the second polymer segments with hydrophilic monomer groups fixed, the molecular weight can be controlled by the amount of the radical initiator in the FRP reaction.

In one preferred example of this embodiment, the anti-biofouling copolymer can be surface-coated on the substrate through hydrophobic physical absorption, and the substrate, as a filtering membrane for water-treatment, can be modified. According to this specification, the anti-biofouling membrane for water-treatment can be produced more conveniently, simply, speedily, and efficiently. Preferably, the surface condition of the substrate will not be changed after the modification, and the pores of the substrate will not be covered during the surface modification of this specification. More preferably, while modified the substrate with the anti-biofouling copolymer, an excellent anti-biofouling membrane with high stability and anti-fouling ability can be obtained.

There are several examples will be disclosed in the following for illustrating the anti-biofouling membrane for water-treatment according to this invention. However, this invention can also be applied extensively to other embodiments, and the scope of this present invention is expressly not limited except as specified in the accompanying claims.

### Example 1

### Synthesis of Anti-Biofouling Copolymer with Diblock Copolymer Form Through Atom Transfer Radical Polymerization (ATRP)

Firstly, styrene is polymerized by ATRP with methyl-2-bromopropionat (MBrP; from Aldrich, purity 98%) as radical initiator, and CuBr (from Aldrich, purity 99.99%) and 2,2′-bipyridyl (BPY; from Acros, purity 99%) as catalyst to obtain polystyrene (PS). While fixing the molar concentration of styrene at 0.39 mol, the average molecular weight of the obtained polystyrene can be controlled by the amount of radical initiator and catalyst. The reacting temperature during the mentioned polymerization is about 120° C., and the reacting time of the mentioned polymerization is 8 hours. After 8 hours, the mentioned polymerization is quenched by ice-bathed. The mentioned polymerization can be illustrated as the following scheme.

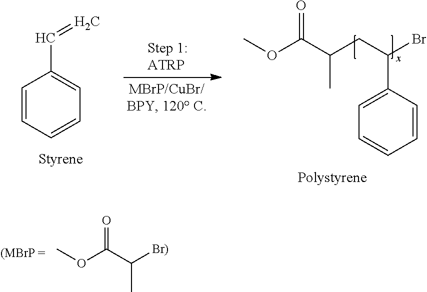

Subsequently, the obtained PS is polymerized with PEGMA in the second step. While fixing the molar concentration of PEGMA at 4.21 mmol, the ratio of the chain length of PS and the chain length of PEGMA can be controlled by the amount of PS. In the mentioned second step, the molar ratio in the polymerization is [PEGMA]/[PS]/[CuBr]/[bpy]=2/1/1/2-150/1/1/2, and the solvent in the polymerization is tetrahydrofuran (THF; from TEDIA, HPLC grade). The reaction temperature in the mentioned second step is about 60° C., and the reacting time of the mentioned in the second step is 24 hours. After 24 hours, the mentioned polymerization in the second step is quenched by ice-bathed. The mentioned polymerization in the second step can be illustrated as the following scheme.

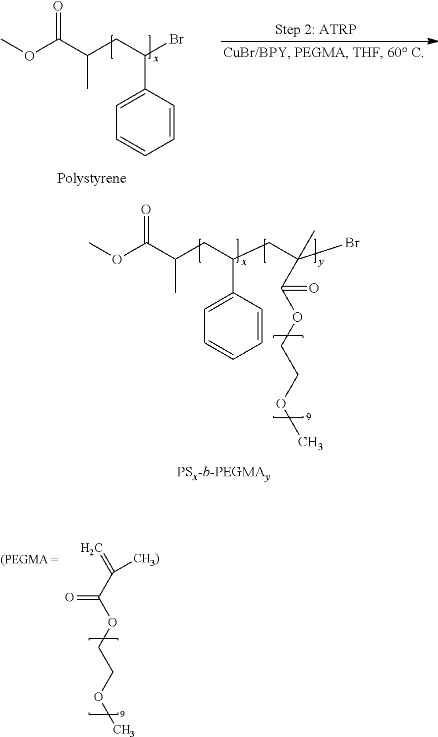

After repeating the above-mentioned procedure with different PS/PEGMA ratio, the obtained result is as the following Table 1.

TABLE 1

| | Mw | | PS | PEGMA | PS/ |
|---|---|---|---|---|---|
| Sample ID | (Da) | PDI | (mol %) | (mol %) | PEGMA |
| PS₂₇-b-PEGMA₁₈ | 11,394 | 1.18 | 60 | 40 | 1.50 |
| PS₅₅-b-PEGMA₉ | 10,003 | 1.48 | 86 | 14 | 6.11 |
| PS₅₅-b-PEGMA₁₃ | 11,853 | 1.44 | 81 | 19 | 4.23 |
| PS₅₅-b-PEGMA₁₇ | 13,407 | 1.40 | 73 | 27 | 3.24 |
| PS₅₅-b-PEGMA₂₀ | 15,099 | 1.22 | 73 | 27 | 2.75 |
| PS₅₅-b-PEGMA₃₀ | 19,985 | 1.15 | 65 | 35 | 1.83 |
| PS₅₅-b-PEGMA₅₈ | 33,219 | 1.15 | 49 | 51 | 0.95 |
| PS₅₅-b-PEGMA₁₁₁ | 58,514 | 1.32 | 33 | 67 | 0.50 |
| PS₅₅-b-PEGMA₁₆₂ | 82,415 | 1.36 | 25 | 75 | 0.34 |
| PS₅₅-b-PEGMA₂₀₉ | 104,837 | 1.25 | 21 | 79 | 0.26 |
| PS₉₄-b-PEGMA₅₁ | 34,096 | 1.16 | 65 | 35 | 1.84 |

### Example 2

### Synthesis of Anti-Biofouling Copolymer with Random Copolymer Form Through Thermal-Induced Free-Radical Polymerization (TFRP)

Styrene is polymerized with PEGMA in the condition with 2,2′-azobisisobutyronitrile (AIBN; from SHOWA) as radical initiator and toluene (from Macron Fine Chemical) as solvent. The reaction concentration of the above polymerization is 30 wt %. The reacting temperature of the above polymerization is about 80° C., and the reacting time of the above polymerization is 24 hours. After 24 hours, the above polymerization is quenched by ice-bathed. The above polymerization can be illustrated as the following scheme.

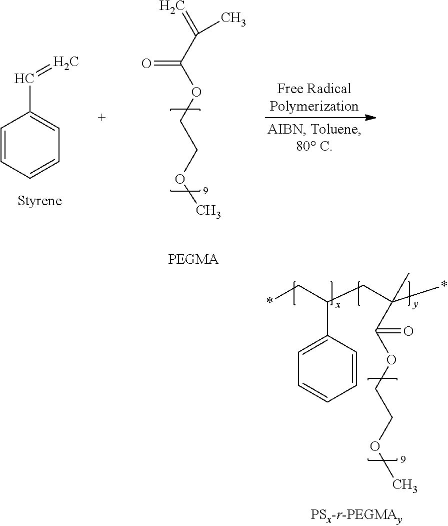

The ratio of PS/PEGMA in the obtained anti-biofouling copolymer can be controlled by the amount of styrene and PEGMA in the above polymerization. And, the average molecular weight of the obtained anti-biofouling copolymer can be controlled by the amount of radical initiator (AIBN). After repeating the above-mentioned procedure with different PS/PEGMA ratio, the obtained result is as the following Table 2.

TABLE 2

| | | | PS/PEGMA |
|---|---|---|---|
| Sample ID | MW | PDI | Ratio |
| PS₆₂-r-PEGMA₁₁₇ | 62,126 | 1.42 | 0.53 |
| PS₁₃₂-r-PEGMA₁₁₂ | 66,961 | 1.54 | 1.17 |
| PS₂₁₁-r-PEGMA₁₀₁ | 70,191 | 1.36 | 2.08 |
| PS₂₄₁-r-PEGMA₇₆ | 60,958 | 1.64 | 3.18 |
| PS₃₂₂-r-PEGMA₇₈ | 70,533 | 1.41 | 4.12 |
| PS₃₄₄-r-PEGMA₆₈ | 68,219 | 1.44 | 5.04 |
| PS₃₂₆-r-PEGMA₁₀₅ | 83,886 | 1.59 | 3.10 |
| PS₁₅₉-r-PEGMA₅₃ | 41,692 | 1.29 | 3.02 |
| PS₈₆-r-PEGMA₂₈ | 22,173 | 1.69 | 3.08 |
| PS₁₅₀-r-PEGMA₁₉ | 24,465 | 1.66 | 8.05 |
| PS₇₂₄-r-PEGMA₁₀₆ | 125,465 | 1.20 | 6.86 |
| PS₃₉₇-r-PEGMA₅₈ | 68,974 | 1.48 | 6.80 |
| PS₅₈₉-r-PEGMA₁₄₉ | 132,085 | 1.43 | 3.95 |
| PS₈₁-r-PEGMA₂₅ | 20,272 | 1.84 | 3.23 |

### Example 3

### Synthesis of Anti-Biofouling Copolymer with Diblock Copolymer Form Through Reversible Addition-Fragmentation Chain Transfer Polymerization (RAFT)

Firstly, styrene monomer is polymerized by RAFT with 4,4′-Azobis(4-cyanovaleric acid)purum, ≧98.0% as radical initiator, and 5-cyano-5-[(phenylcarbonothioyl)thio]hexanoic acid as reagent to obtain polystyrene (PS). While fixing the molar concentration of styrene at 2.54 M, the average molecular weight of the obtained polystyrene can be controlled by the relative amount of radical initiator and catalyst. The reacting temperature during the mentioned polymerization is about 80° C., and the reacting time of the mentioned polymerization is 6 hours. After 6 hours, the mentioned polymerization is quenched by ice-bath. The mentioned polymerization can be illustrated as the following scheme.

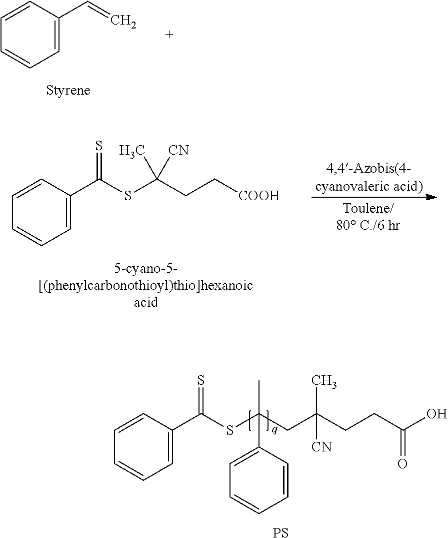

Subsequently, the obtained PS is polymerized with PEGMA macromonomer in the second step. While fixing the concentration of PEGMA at 30 wt %, the ratio of the chain length of PS and the chain length of PEGMA can be controlled by the amount of PS. In the mentioned second step, the molar ratio in the polymerization is [PS-reagent]/[Initiator]=1/0.2, and the solvent in the polymerization is Toluene. The reaction temperature in the mentioned second step is about 80° C., and the reacting time of the mentioned in the second step is 16 hours. After 16 hours, the mentioned polymerization in the second step is quenched by ice-bath. The mentioned polymerization in the second step can be illustrated as the following scheme.

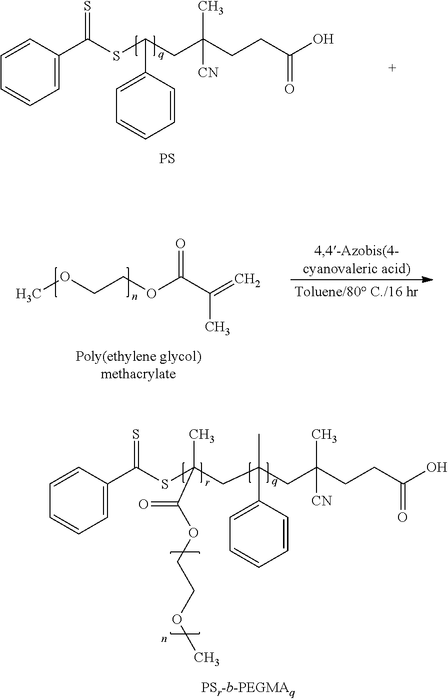

After repeating the above-mentioned procedure with different PS/PEGMA ratio, the obtained result is as the following Table 3.

TABLE 3

| | Mw | | PS | PEGMA | |
|---|---|---|---|---|---|
| Sample ID | (Da) | PDI | (mol %) | (mol %) | PS/PEGMA |
| PS₅₄-b-PEGMA₂₈ | 19,874 | 1.44 | 60 | 30 | 2 |
| PS₅₄-b-PEGMA₅₆ | 32,224 | 1.78 | 60 | 60 | 1 |
| PS₅₄-b-PEGMA₁₁₇ | 61,199 | 1.33 | 60 | 120 | 0.5 |

### Example 4

### Synthesis of Anti-Biofouling Copolymer with Triblock Copolymer Form Through Reversible Addition-Fragmentation Chain Transfer Polymerization (RAFT)

Firstly, PEGMA macromonomer is polymerized by RAFT with 4,4′-Azobis(4-cyanovaleric acid)purum, 98.0% as radical initiator, and 5-cyano-5-[(phenylcarbonothioyl)thio]hexanoic acid as reagent to obtain PEGMA polymer. While fixing the molar concentration of styrene at 2.54 M, the average molecular weight of the obtained polystyrene can be controlled by the amount of radical initiator and catalyst. The reacting temperature during the mentioned polymerization is about 80° C., and the reacting time of the mentioned polymerization is 6 hours. After 6 hours, the mentioned polymerization is quenched by ice-bath. The mentioned polymerization can be illustrated as the following scheme.

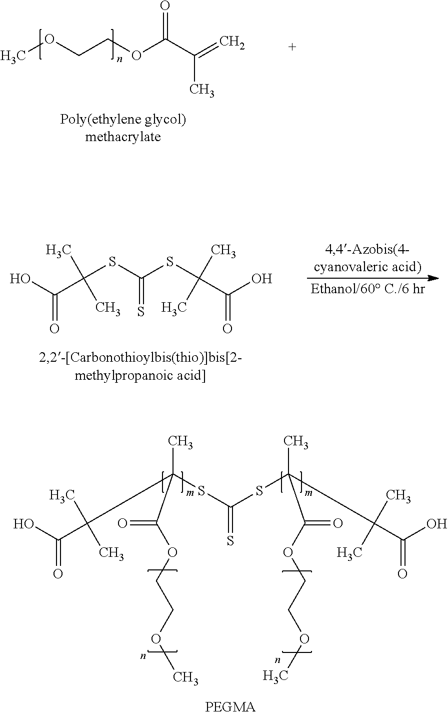

Subsequently, the obtained PEGMA is polymerized with styrene monomer in the second step. While fixing the concentration of styrene at 30 wt %, the ratio of the chain length of PS and the chain length of PEGMA can be controlled by the amount of styrene. In the mentioned second step, the molar ratio in the polymerization is [PEGMA-reagent]/[Initiator]=1/0.2, and the solvent in the polymerization is Toluene. The reaction temperature in the mentioned second step is about 80° C., and the reacting time of the mentioned in the second step is 16 hours. After 16 hours, the mentioned polymerization in the second step is quenched by ice-bath. The mentioned polymerization in the second step can be illustrated as the following scheme.

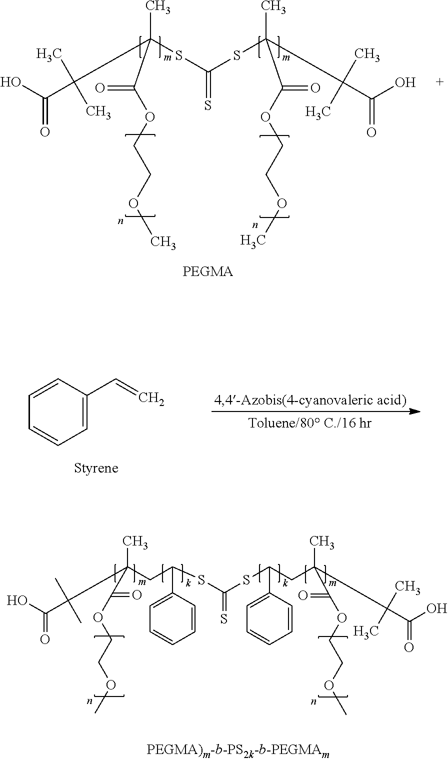

After repeating the above-mentioned procedure with different PS/PEGMA ratio, the obtained result is as the following Table 4.

TABLE 4

| | | | PS/PEGMA |
|---|---|---|---|
| Sample ID | MW | PDI | Ratio |
| PEGMA₄₅-b-PS₆₃-b-PEGMA₄₅ | 45,773 | 2.94 | 1.4:1:1.4 |
| PEGMA₁₂₈-b-PS₆₃-b-PEGMA₁₂₈ | 67,797 | 1.90 | 0.49:1:0.49 |
| PEGMA₃₉-b-PS₇₂-b-PEGMA₃₉ | 28,886 | 2.05 | 1.84:1:1.84 |
| PEGMA₁₀₁-b-PS₇₂-b-PEGMA₁₀₁ | 55,858 | 3.47 | 0.71:1:0.71 |
| PEGMA₁₆₂-b-PS₇₂-b-PEGMA₁₆₂ | 84,742 | 2.02 | 0.44:1:0.44 |

### Example 5

### Producing the Anti-Biofouling Membrane for Water-Treatment by Surface-Coating Diblock Copolymer Form Anti-Biofouling Copolymer (PSₘ-b-PEGMAₙ) on a Substrate

1. PVDF film (0.1 μm) is cut as small parts with 13 mm diameter, and the small parts are put into a glass container. After adding 200 mL ethanol (99.5%) into the glass container, the glass container is oscillated under ultra-sonic oscillator for 1 hour. The above procedure is repeated for several times and the solvent in the glass container is sequentially changed between deionized water and ethanol for cleaning the small part PVDF films in the glass container. After cleaning, the small part PVDF films are respectively put into a 24 well plate for drying process. While completely dried, the small part PVDF films are respectively weighed by a 5-digit weighing balance (Mettler Toledo, XP105, from Switzerland) to get the dried weight value W₀ of every PVDF film.

2. After calculating the concentration of the anti-biofouling copolymer, the anti-biofouling copolymer is weighed in required weight, and the weighed anti-biofouling copolymer is dissolved by 99.5 wt % ethanol to obtain an anti-biofouling copolymer solution.

3. The mentioned weighed PVDF films are individually put into 5 mL sample glass bottle, and 1 mL anti-biofouling copolymer solution is added into each glass bottle. Those glass bottles are oscillated under ultra-sonic oscillator for 1 hour, and then those glass bottles are at room temperature for 23 hours for the anti-biofouling copolymer completely absorbed onto the PVDF films.

4. The PVDF films are taken out, and washed with 50 wt % ethanol and deionized water sequentially for removing those anti-biofouling copolymer not absorbed by the PVDF films. Then, those PVDF films are dried in a 24 well plate.

5. After the PVDF films completely dried, the PVDF films are respectively weighed by the 5-digit weighing balance to get the weight value W₁ of every PVDF film coated with the anti-biofouling copolymer. The difference weight value (W₀−W₁) represents the amount of the anti-biofouling copolymer absorbed on the PVDF film. The difference weight value divided by the surface area of the PVDF film equals to the density of the anti-biofouling copolymer amount absorbed on the PVDF film.

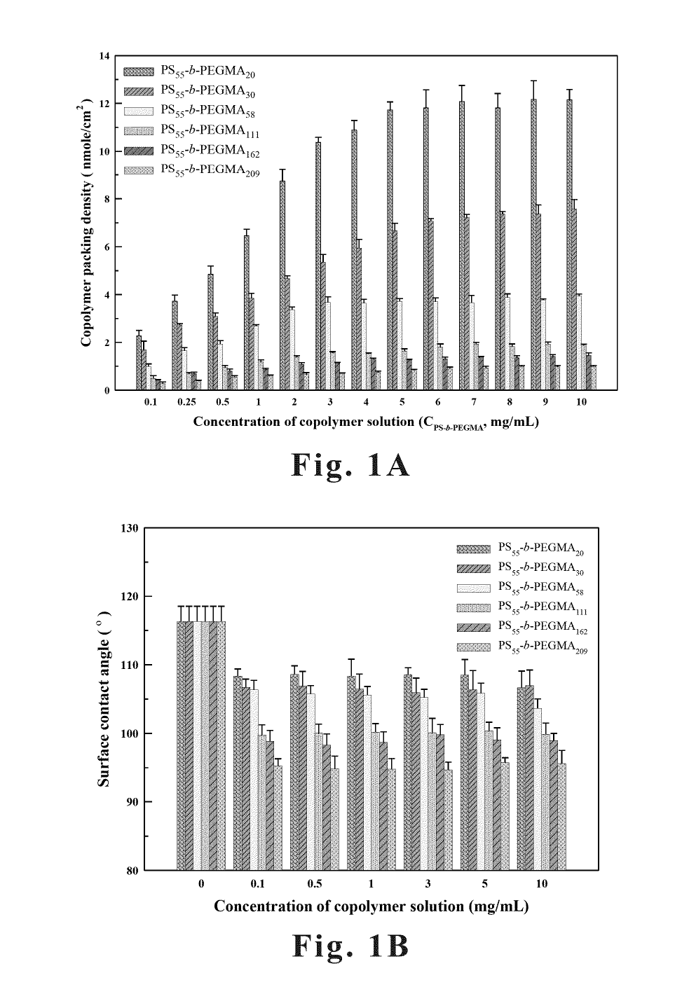

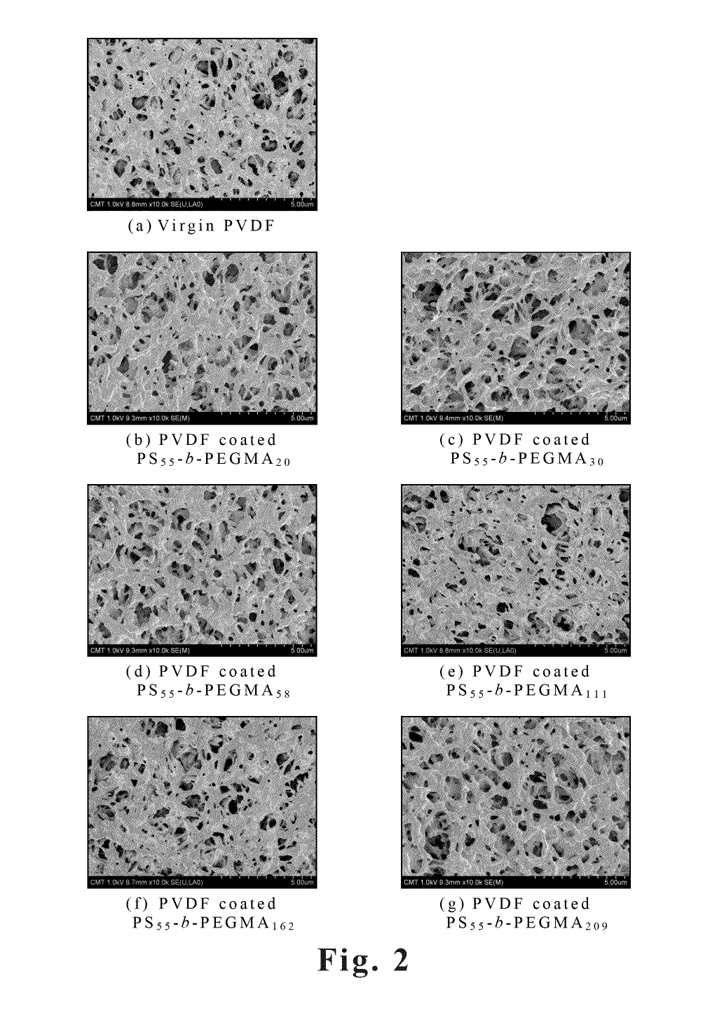

After repeating the above-mentioned procedures with different PS/PEGMA ratio in the anti-biofouling copolymer, the obtained result is presented as FIG. 1A and FIG. 1B. FIG. 2 presents the SEM (scanning electron microscopy) images of surface morphology of non-coated PVDF film as the substrate of this invention, and the PVDF films coated with the anti-biofouling copolymer with diblock copolymer form with different PS/PEGMA ratio. The coating concentration of PSₘ-b-PEGMAₙ on the PVDF film is about 10 mg/mL. According to FIG. 2, we can easily find that the surface pore size of the PVDF films is almost not changed. That is to say, the physical structure characteristic of the substrate PVDF will not be changed while coating with the anti-biofouling copolymer PSₘ-b-PEGMAₙ of this invention.

### Example 6

### Producing the Anti-Biofouling Membrane for Water-Treatment by Surface-Coating Random Copolymer Form Anti-Biofouling Copolymer (PSₘ-r-PEGMAₙ) on a Substrate

1. PVDF film (0.1 μm) is cut as small parts with 13 mm diameter, and the small parts are put into a glass container. After adding 200 mL ethanol (99.5%) into the glass container, the glass container is oscillated under ultra-sonic oscillator for 1 hour. The above procedure is repeated for several times and the solvent in the glass container is sequentially changed between deionized water and ethanol for cleaning the small part PVDF films in the glass container. After cleaning, the small part PVDF films are respectively put into a 24 well plate for drying process. After completely dried, the small part PVDF films are respectively weighed by a 5-digit weighing balance (Mettler Toledo, XP105, from Switzerland) to get the dried weight value W₀ of every PVDF film.

2. After calculating the anti-biofouling copolymer concentration, the anti-biofouling copolymer is weighed in required weight, and the weighed anti-biofouling copolymer is dissolved by 90.0 wt % ethanol to obtain an anti-biofouling copolymer solution.

3. The mentioned weighed PVDF films are individually placed into glass Petri dishes, and the front side of the PVDF films are toward up. After calculating the volume of the wanted coating anti-biofouling copolymer density, the anti-biofouling copolymer solution is dropped onto the surface of the PVDF films. The anti-biofouling copolymer is dropped for several times and small amount in each time to coat onto the up side and down side of the PVDF films.

4. After the PVDF films completely dried, the PVDF films are respectively weighed by the 5-digit weighing balance to get the weight value W₁ of every PVDF film coated with the anti-biofouling copolymer. The difference weight value (W₀−W₁) represents the amount of the anti-biofouling copolymer absorbed on the PVDF film. The difference weight value divided by the surface area of the PVDF film equals to the density of the anti-biofouling copolymer amount absorbed on the PVDF film.

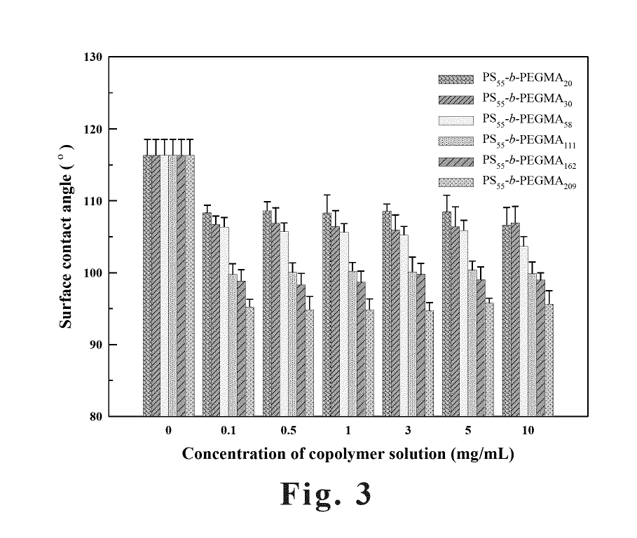

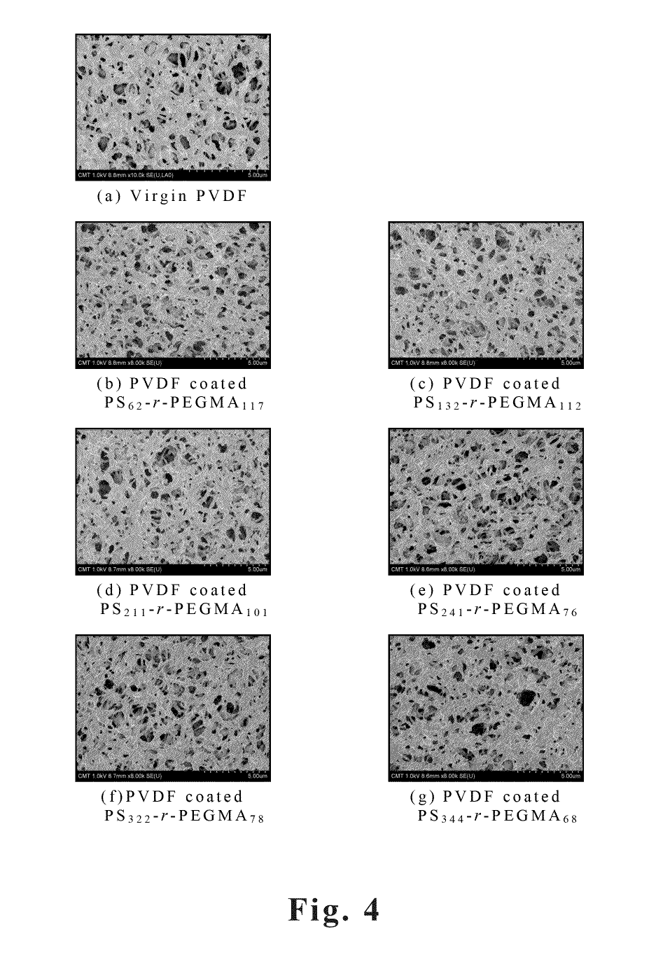

The above-mentioned procedures are repeated for several times with different PS/PEGMA ratio of the anti-biofouling copolymer, and the obtained result is presented as FIG. 3. FIG. 4 presents the SEM (scanning electron microscopy) images of surface morphology of non-coated PVDF film as the substrate of this invention, and the PVDF films coated with the anti-biofouling copolymer with random copolymer form with different PS/PEGMA ratio. The coating density of PSₘ-r-PEGMAₙ on the PVDF film is about 0.2 mg/cm². According to FIG. 4, we can easily find that the surface pore size of the PVDF films is almost not changed. That is to say, the physical structure characteristic of the substrate PVDF will not be changed while coating with the anti-biofouling copolymer PSₘ-r-PEGMAₙ of this invention.

### Example 7

### Test of Biofouling Resistance to Proteins of the Anti-Biofouling Membrane with Diblock Copolymer PSₘ-b-PEGMAₙ

In the test of biofouling resistance to proteins of the anti-biofouling membrane, two proteins, bovine serum albumin (BSA; from Sigma) and lysozyme (LY; from Sigma), are used to perform the static absorption test for evaluating the ability of proteins absorption resistance of the anti-biofouling membrane coated with the anti-biofouling copolymer of this invention. The test procedure is as following:

1. Deionized water is used to prepare 1 L phosphate buffered saline (PBS, from Sigma), and the pH of the prepared PBS solution is about 7.4.

2. The PBS solution is used as solvent to preparing a protein solution. The concentration of the protein solution is 1 mg/mL.

3. The target anti-biofouling membranes are rinsed with 50 wt % ethanol, and dipped into 1 mL deionized water in a sample glass bottle. The deionized water in the sample flask is changed for 3 times for ensuring no residual ethanol in the glass bottle. Then, the deionized water in the sample glass bottle is replaced by the PBS solution, and the target anti-biofouling membranes are statically placed in the PBS solution for 3 hours. After replacing the PBS solution in the glass bottle by the protein solution, the target anti-biofouling membranes are statically placed in the protein solution for 3 hours. Subsequently, the test of protein absorption of the target anti-biofouling membranes can be performed.

4. Multi-mode microplate readers (Spectramax M5, from Molecular Devices, USA) is used to measure the protein concentration of the injected sample. The absorption wave length of the multi-mode microplate readers is set at 280 nm, and the injected sample volume is 200 μL.

5. Several protein solutions with different concentration as 0 (the PBS solution without adding the protein solution), 125, 250, 500, 750, and 1000 mg/L are prepared, and each of the mentioned protein solutions can obtain a corresponding absorption value from the multi-mode microplate readers. A calibration curve of protein concentration versus absorption value can be built, and the curvilinear regression value of the mentioned calibration curve must larger than 0.995.

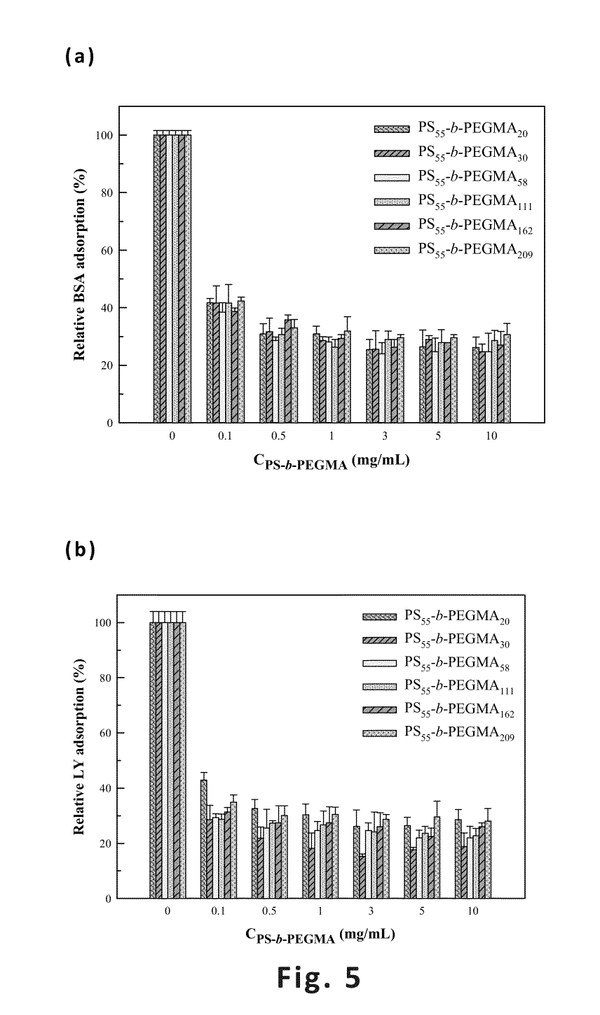

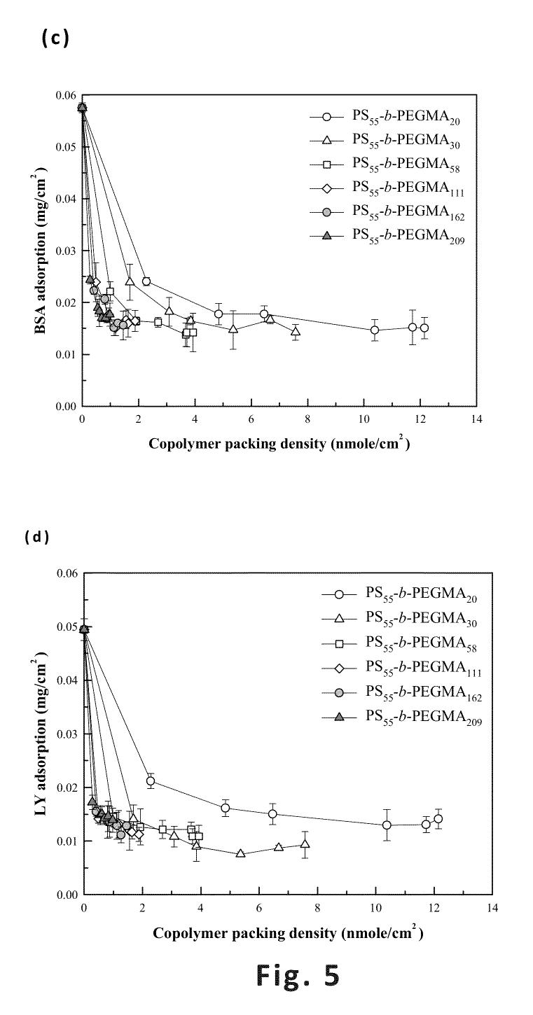

6. The sample solutions are sequentially injected into the multi-mode microplate readers for measuring the absorption values. The residual protein concentration of the sample solution on the anti-biofouling membrane can be calculated out by taking the measured absorption value into the mentioned calibration curve. And, according to the difference between the calculated residual protein concentration and the original protein concentration of the protein solution (1 mg/mL, mentioned in the above), the amount of the protein absorbed by the anti-biofouling membrane can be calculated out. The above-mentioned procedures are repeated for several times with different PS/PEGMA ratio of the anti-biofouling copolymer, and the obtained result is presented as FIG. 5.

### Example 8

### Test of Biofouling Resistance to Proteins of the Anti-Biofouling Membrane with Random Copolymer PSₘ-r-PEGMAₙ

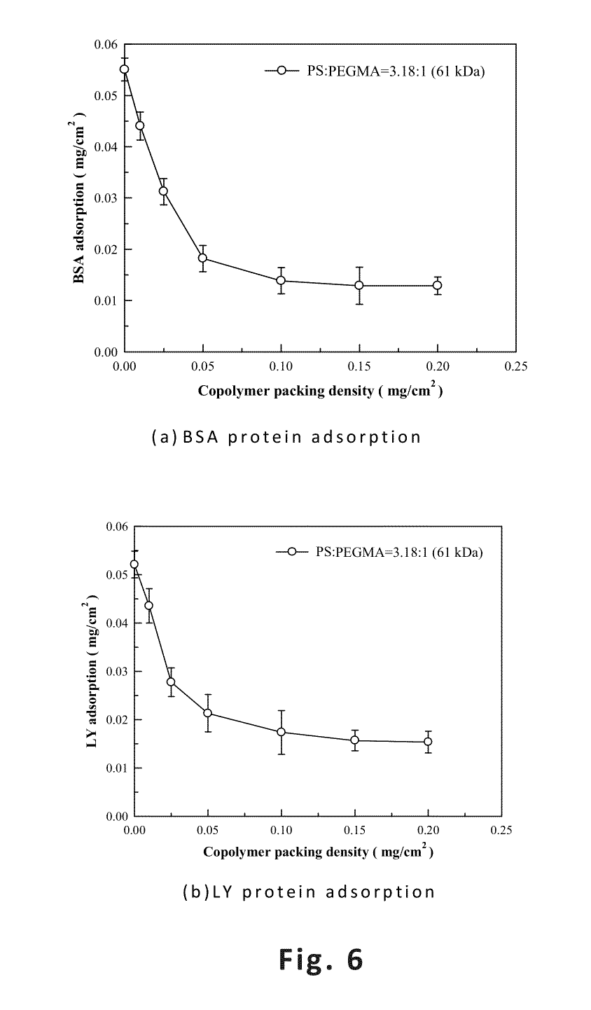

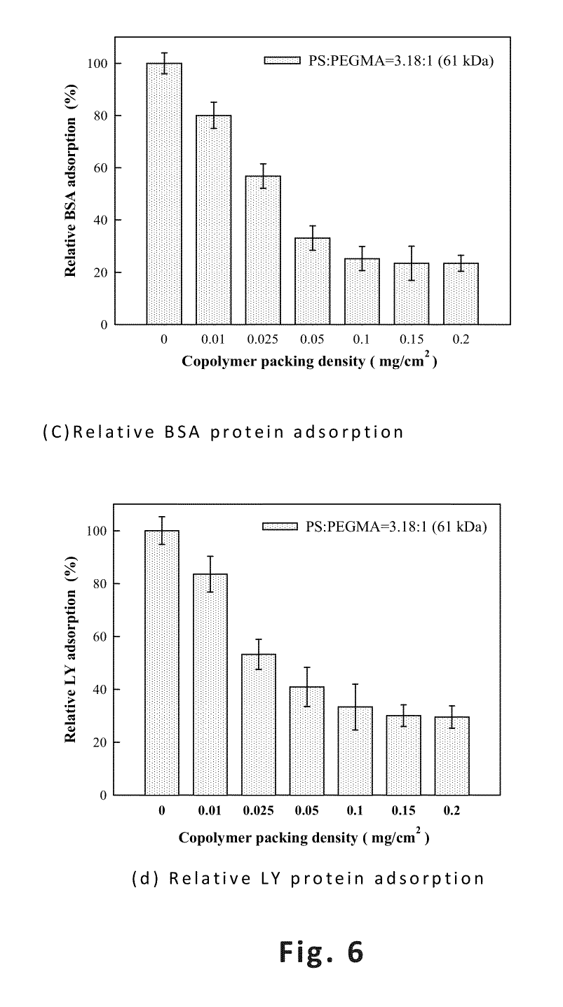

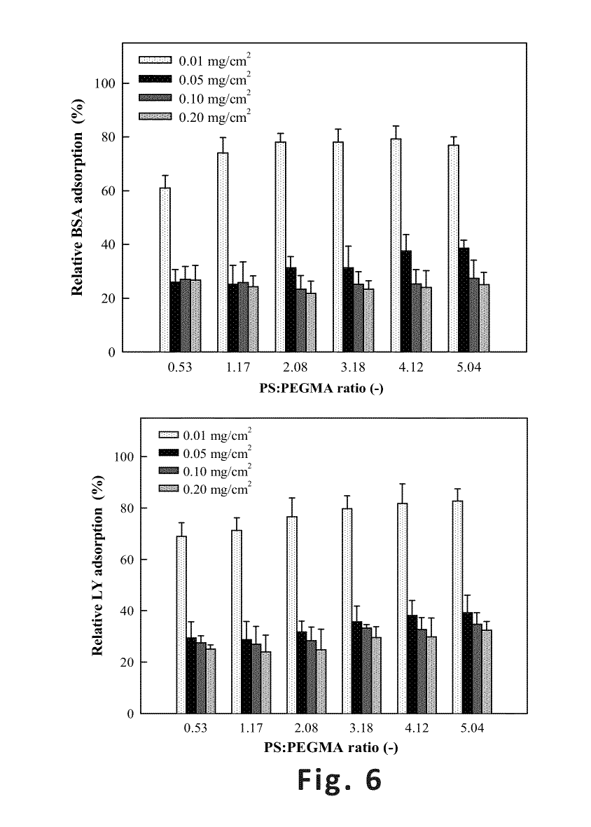

The test of biofouling resistance to proteins of the anti-biofouling membrane with random copolymer PSₘ-r-PEGMAₙ can be accomplished by repeating the above-mentioned procedures in Example 7 for several times with the different PS/PEGMA ratio of the anti-biofouling copolymer PSₘ-r-PEGMAₙ, and the obtained result is presented as FIG. 6.

### Example 9

### Test of Biofouling Resistance to Bacteria of the Anti-Biofouling Membrane with Diblock Copolymer PSₘ-b-PEGMAₙ

In order to test the biofouling resistance to bacteria of the anti-biofouling membrane, two strains of bacteria, including Stenotrophomonas epidermidis (S. epidermidis; model number: ATCC 12228) and Escherichia coli (E. coli; model number: ATCC23225), are bought from Bioresource Collection and Research Center. The mentioned bacteria are also known as Gram-positive bacterium and Gram-negative bacterium. Before experimental operation, it must be ensured that the bacteria are not polluted. The bacteria should be activated. When the bacteria are grown to a stable status, it is performed that the bacteria solution is placed to the anti-biofouling membrane for 24 hours contacting test. Whole the test must be operated on Laminar Flow. The procedure is as following:

1. Un-modified and modified membrane are put into a 24 well plate, and washed by deionized water for 3 times.

2. 3 g beef extract and 5 g soy peptone are dissolved in 1 L deionized water for preparing a culture solution. 50 mL culture solution is placed in a flask. All units during this test are put into a sterilizing tank and under a UV sterilizing process.

3. The frozen strains are taken out from −20° C. refrigerator. After defrosted, 3.6 mL bacteria is taken out, injected into a 50 mL petri dish, and grown at 37° C. to a stable status. For S. epidermidis, it takes about 18 hours to achieve the mentioned grown stable status, and the concentration of S. epidermidis at the stable status is 10⁹ cells/mL. For E. coli, the growth period for achieve the mentioned stable status is 12 hours, and the concentration of E. coli at the stable status is 10⁶ cells/mL.

1 mL of the cultured bacteria is added into the 24 well plate, and then the 24 well plate is placed in a 37° C. incubator for performing the test of the biofouling resistance to bacteria of the anti-biofouling membrane. The bacteria in the 24 well plate must be renewed every 6 hours. The mentioned test in the incubator is performed for 24 hours. The volume of the culture fluid in the flask is kept at 50 mL. If the volume of the culture fluid decreased, new culture fluid should be added into the flask for keeping the bacteria being in saturated status.

5. After culturing for 24 hours, the residual bacteria in the 24 well plate is removed, and the mentioned anti-biofouling membrane is washed by deionized water for 3 times for removing the bacteria not adhered to the anti-biofouling membrane.

6. SEM (scanning electron microscopy) is used to observe the surface morphology of the anti-biofouling membrane adhered with the bacteria. First of all, the deionized water is removed from the 24 well plate. 0.8 mL glutaraldehyde with 1 wt % (from Acros organics Co.) is added into the 24 well plate, and the 24 well plate is placed in refrigerator for 2 hours. Then, glutaraldehyde is removed from the 24 well plate, and the 24 well plate is washed with deionized water for 3 times in order to fix the bacteria adhered on the anti-biofouling membrane and avoid the adhered bacteria fallen from the anti-biofouling membrane while observing with SEM. The 24 well plate is placed in a vacuum drying box for 24 hours.

7. Before observing with SEM, a gold plating process must be performed on the anti-biofouling membranes with bacteria for 100 seconds. The surface morphology of the anti-biofouling membrane is taken by SEM at 8 random and different positions of the anti-biofouling membrane for observing the bacteria adhered on the anti-biofouling membrane. While observing, the surface morphology of the anti-biofouling membrane is amplified 8000 times. The performance of the biofouling resistance to bacteria of the anti-biofouling membrane is determined by counting the average value and the standard deviation of the bacteria on the anti-biofouling membrane.

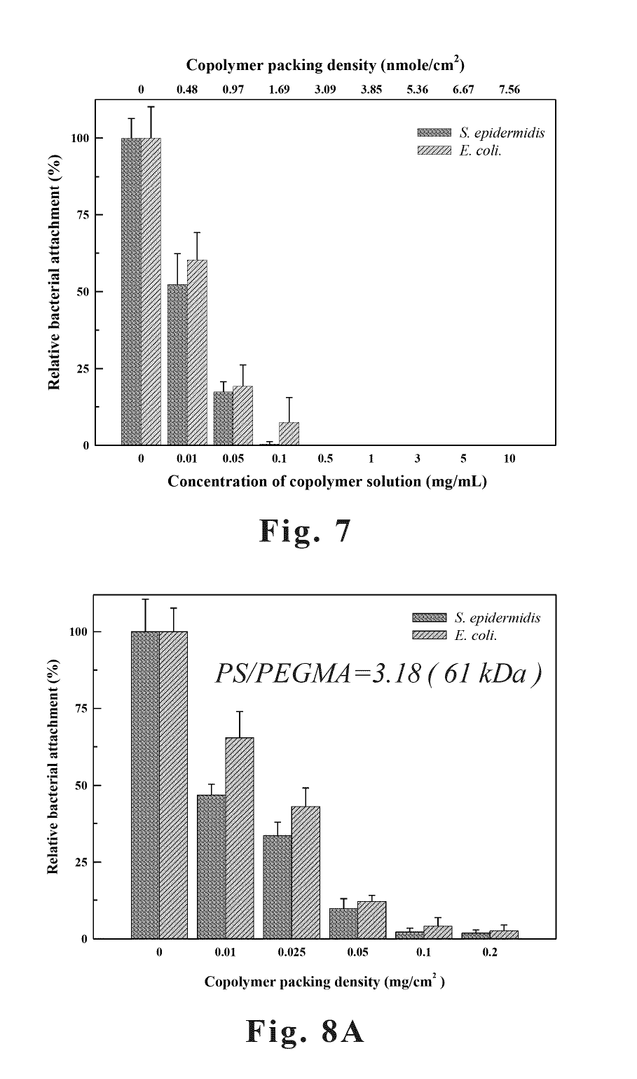

The results of the test of the biofouling resistance to bacteria of the anti-biofouling membranes with different PS/PEGMA ratio of diblock copolymer (PSₘ-b-PEGMAₙ) are presented as FIG. 7.

### Example 10

### Test of Biofouling Resistance to Bacteria of the Anti-Biofouling Membrane with Random Copolymer PSₘ-r-PEGMAₙ

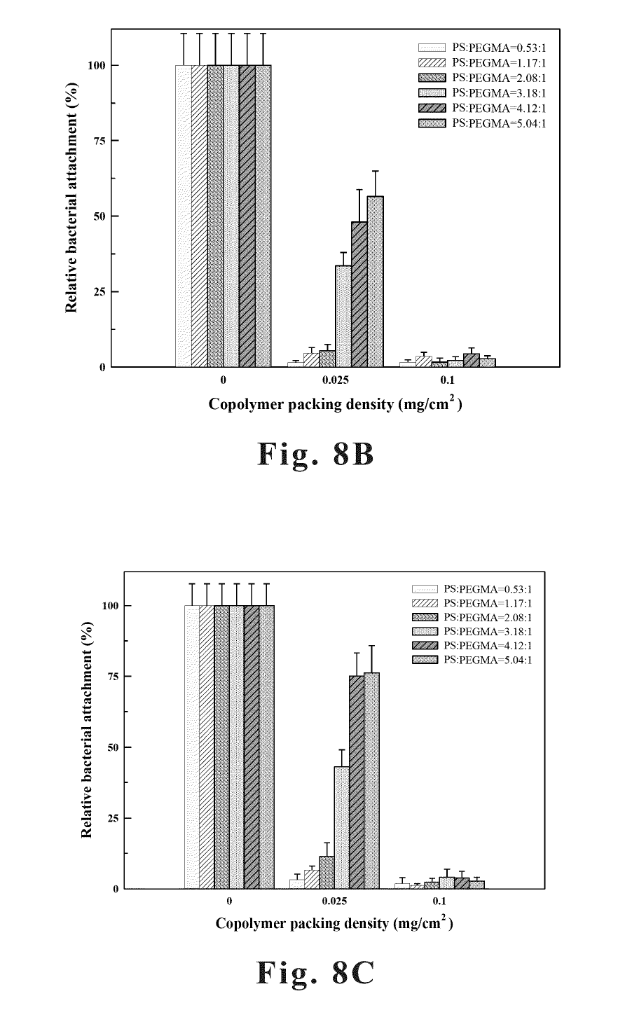

The test of biofouling resistance to bacteria of the anti-biofouling membrane with random copolymer PSₘ-r-PEGMAₙ can be accomplished by using the anti-biofouling membranes with the different PS/PEGMA ratio of the anti-biofouling copolymer PSₘ-r-PEGMAₙ repeating the above-mentioned procedures in Example 9, and the obtained results are presented as FIG. 8A to FIG. 8C.

### Example 11

### Test of Anchoring Capability in DI Water Solution and Anti-Fouling Stability of the Anti-Biofouling Membrane with Anti-Biofouling Copolymer PSₘ-PEGMAₙ

In order to test the anchoring capability of the anti-biofouling copolymer coated on the membrane, the test in this example is performed with deionized water by dipping long time. In this example, the stability is also evaluated by the weight value difference and the anti-fouling ability to protein. The procedure is as following:

1. PVDF film (13 mm diameter) is washed, dried, and weighed to get the net weight. Then, the PVDF film is coated with the anti-biofouling copolymer to obtain the test membrane in this example. After dried, the test membrane is weighed to get the coated amount of the anti-biofouling copolymer on the PVDF film.

After rinsed with 50 wt % ethanol, the test membrane is dipped into 10 mL deionized water in a 20 mL sample glass bottle, and statically placed for 1, 3, 7, 14, 30, 45, and 60 days.

3. The test membrane is taken out at the set test time, dried, and weighed. The weight percentage of the residual anti-biofouling copolymer on the PVDF film can be determined by the weight difference between the weight values before and after dipped in the deionized water.

4. The weighed test membrane in the above step 3 is subsequently employed in the test of BSA protein absorption for observing whether the test membrane of this example still have the anti-fouling capability to protein. The above test of BSA protein absorption is operated as the procedures disclosed in the above Example 7.

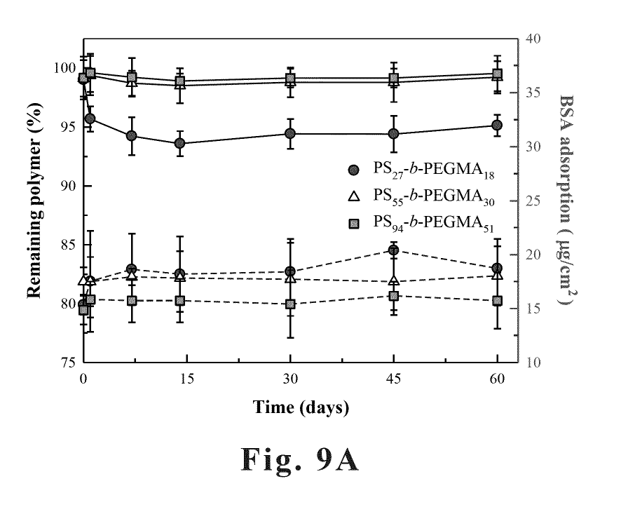

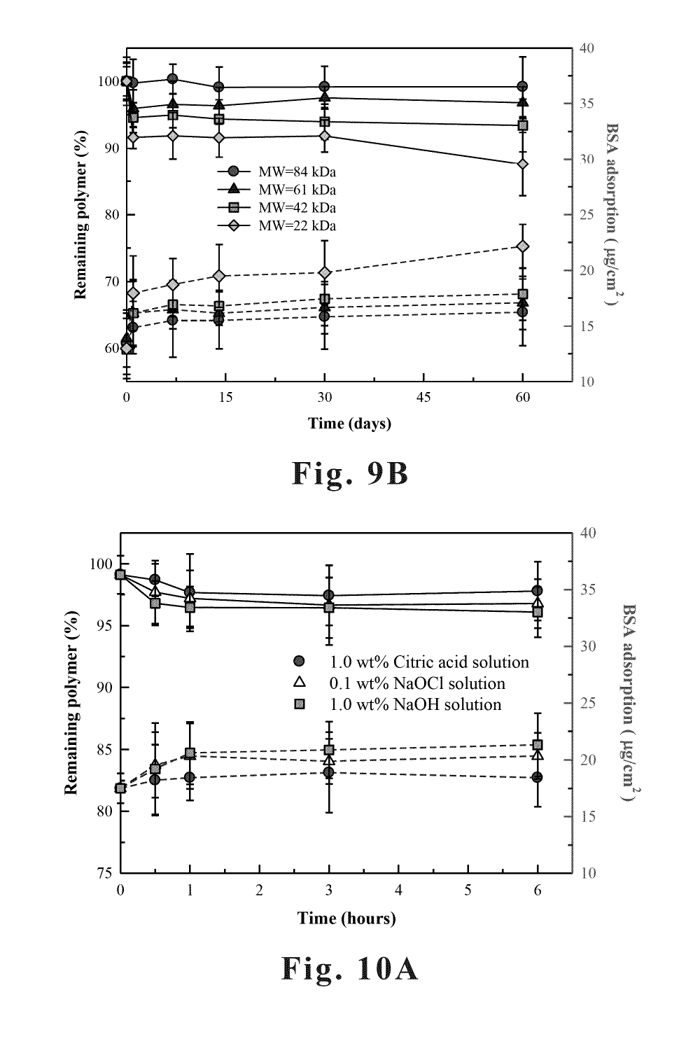

The test of anchoring capability in DI water solution and anti-fouling stability of the anti-biofouling membrane coated with different PS/PEGMA ratio of diblock copolymer PSₘ-b-PEGMAₙ and different PS/PEGMA ratio of random copolymer PSₘ-r-PEGMAₙ are performed in the above mentioned procedures, and the obtained results are respectively presented as FIG. 9A and FIG. 9B.

### Example 12

### Test of Anchoring Capability in Acidic and Basic Solutions and Anti-Fouling Stability of the Anti-Biofouling Membrane with Anti-Biofouling Copolymer PSₘ-PEGMAₙ

In order to test the anchoring capability of the anti-biofouling copolymer coated on the membrane, the test in this example is performed by washed with acidic and basic solutions. In this example, the stability is also evaluated by the weight value difference and the anti-fouling ability to protein. The procedure is as following:

1. PVDF film (13 mm diameter) is washed, dried, and weighed to get the net weight. Then, the PVDF film is coated with the anti-biofouling copolymer to obtain the test membrane of this example. After dried, the test membrane is weighed to get the coated amount of the anti-biofouling copolymer on the PVDF film.

2. The acidic and basic solutions are individually prepared. The acidic solution is 1 wt % citric acid (C₆H₈O₇; from Tokyo Chemical Industry Co.). The basic solution is 0.1 wt % sodium hydroxide (NaOH; from Merck). The pH value of the acidic and the basic solutions are respectively measured.

3. After rinsed with 50 wt % ethanol, the test membranes are respectively dipped into 1 mL acidic solution/basic solution in a 5 mL sample glass bottle, and respectively washed by ultra-sonic oscillating for 0.5, 1, 3, 6, 12, and 24 hours.

4. After the oscillating process, the liquid in the sample glass bottle is replaced with 5 mL deionized water, and the sample glass bottle is performed another oscillating process for 10 minutes. After repeating the procedures of replacing the liquid in the sample glass bottle with deionized water and oscillating for 3 times, the test membrane is taken out, and washed with deionized water for removing the residual acidic or basic solute on the test membrane. The test membrane is dried and weighed. The weight percentage of the residual anti-biofouling copolymer on the PVDF film can be determined by the weight difference between the weight values before and after performing the washing process with acidic/basic solution.

5. The weighed test membrane in the above step 4 is subsequently employed in the test of BSA protein absorption for observing whether the test membrane of this example still have the anti-fouling capability to protein. The above test of BSA protein absorption is operated as the procedures disclosed in the above Example 7.

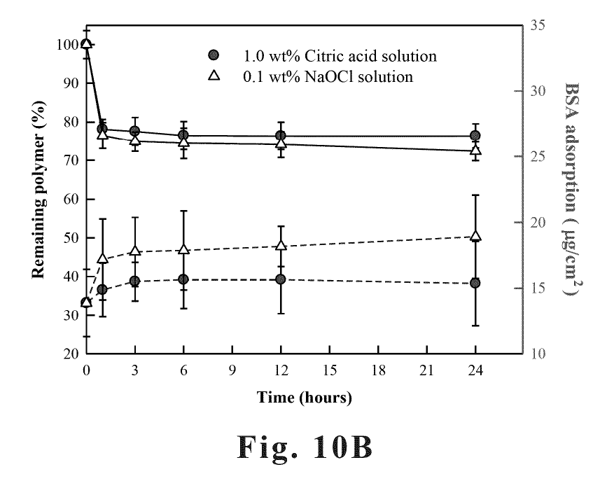

The test of anchoring capability in acidic and basic solutions and anti-fouling stability of the anti-biofouling membrane coated with different PS/PEGMA ratio of diblock copolymer PSₘ-b-PEGMAₙ and different PS/PEGMA ratio of random copolymer PSₘ-r-PEGMAₙ are performed in the above mentioned procedures, and the obtained results are respectively presented as FIG. 10A and FIG. 10B.

### Example 13

### Test of Water-Treatment with the Membrane Bioreactor (MBR) with the Anti-Biofouling Membrane with Anti-Biofouling Copolymer PSₘ-PEGMAₙ

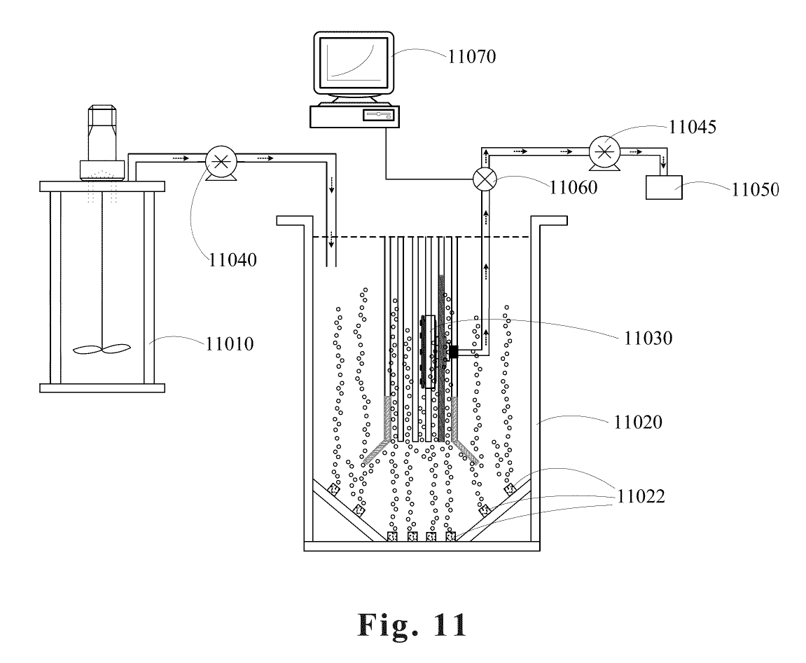

In this example, in order to evaluate the performance of the anti-biofouling membrane for water-treatment, the anti-biofouling membrane with the anti-biofouling copolymer PSₘ-PEGMAₙ is applied in MBR for the test of water-treatment capability. The apparatus of a MBR system for performing the membrane filtration test is designed by the inventors of this invention and illustrated as FIG. 11.

14 L active sludge is poured into the reaction tank 11020. The active sludge is from Taipei domestic wastewater treatment works. The concentration of the suspension solid (SS) therein is 2000 to 4000 mg/L, and the solids retention time (SRT) of the active sludge is 30 days. The matrix diluted in 300 times is introduced from the feeding tank 11010 and is as the feeding solution. The COD concentration of the matrix is about 250 mg/L, and the composition is shown in Table 5. In the MBR system, membrane module 11030 is disposed in the reaction tank 11020. The MBR system comprises a first peristaltic pump 11040 for driving the matrix into the reaction tank 11020. The MBR system comprises a second peristaltic pump 11045 for driving the liquid in the reaction tank 11020 across the membrane model 11030 to an effluent 11050. The permeated flux of the membrane is controlled at about 20 L/m² hr by the second peristaltic pump 11045. The fouling level is evaluated by the trans-membrane pressure (TMP) measured by the pressure gauge 11060. There is a plurality of aeration pore 11022 disposed at the lower portion of the reaction tank 11020. Each of the aeration pores 11022 is coupled with an aeration machine, not shown in the figure. The aeration pores 11022 can provide air into the reaction tank 11020 for providing oxygen to the active sludge. The aeration pores 11022 can provide shearing stress to the surface of membrane module 11030 for slowing down the membrane fouled. The effective filtration area of the membrane in the membrane module 11030 is about 12.57×10⁻⁴ m². The operating procedures are as following:

1. After rinsed, the membrane is fixed on a multi-porous supporting layer. A stainless sheet is disposed on the membrane, and a plurality of screws is fixed to form the mentioned membrane module 11030. While fixing the screws, it is important to keep the membrane being flat and not move the membrane to cause any chink.

2. Two membrane modules 11030 are disposed into the reaction tank 11020 at the same time. The membrane modules are respectively installed a membrane substrate without any coated polymer and a membrane substrate coated with the anti-biofouling copolymer of this specification. The first peristaltic pump 11040 and the second peristaltic pump 11045 are turned on, and the permeated flux of the membrane is controlled at about 20 L/m² hr by the second peristaltic pump 11045. The monitoring device 11070 is activated for monitoring and recording the pressure value measured by the pressure gauge 11060.

3. When the TMP achieving 0.45 bar, the first peristaltic pump 11040, the second peristaltic pump 11045, the monitoring device 11070, and the aeration machine are turned off for depositing the active sludge in the reaction tank 11020. The membrane modules 11030 are taken out, and the membrane surface is washed with water. After washed with water, the membrane modules are disposed into the reaction tank 11020, and are ready for next cyclic operation.

4. The above step 3 is repeated until accomplished 20 times membrane filtration test.

TABLE 5

| Components | Content in 1 L DI water (pH 6.9 ± 0.3) | |
|---|---|---|
| Milk powder | 72.86 | g |
| Urea, CH₄N₂O | 16.07 | g |
| Sucrose, C₁₂H₂₂O₁₁ | 7.25 | g |
| (NH₄)₂SO₄ | 5.13 | g |
| KH₂PO₄ | 7.25 | g |
| FeCl₃ | 0.05 | g |
| CH₃COOH | 4.47 | mL |

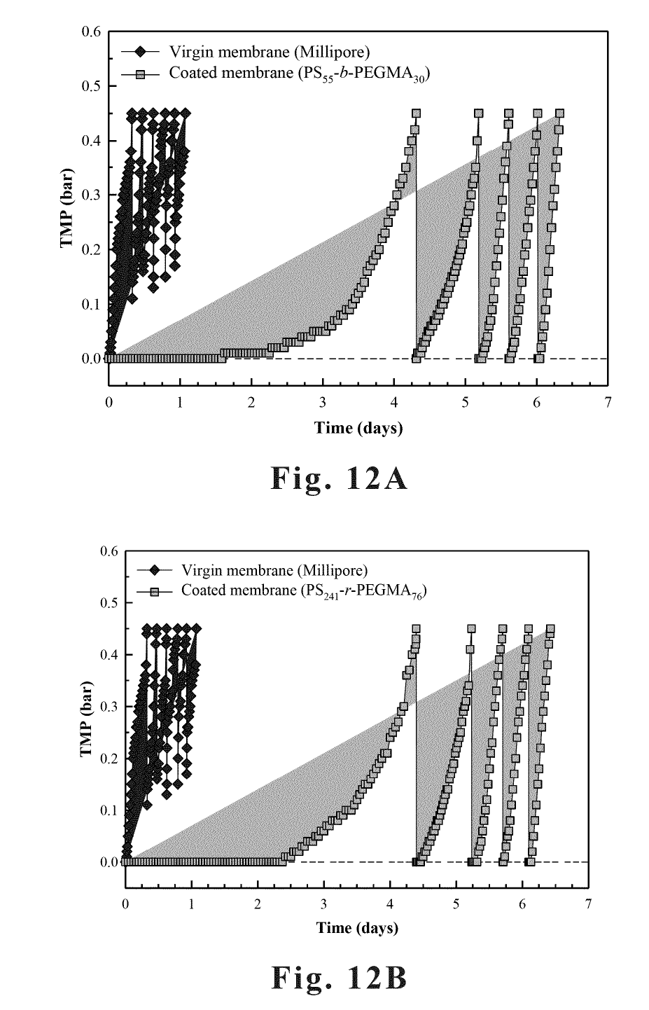

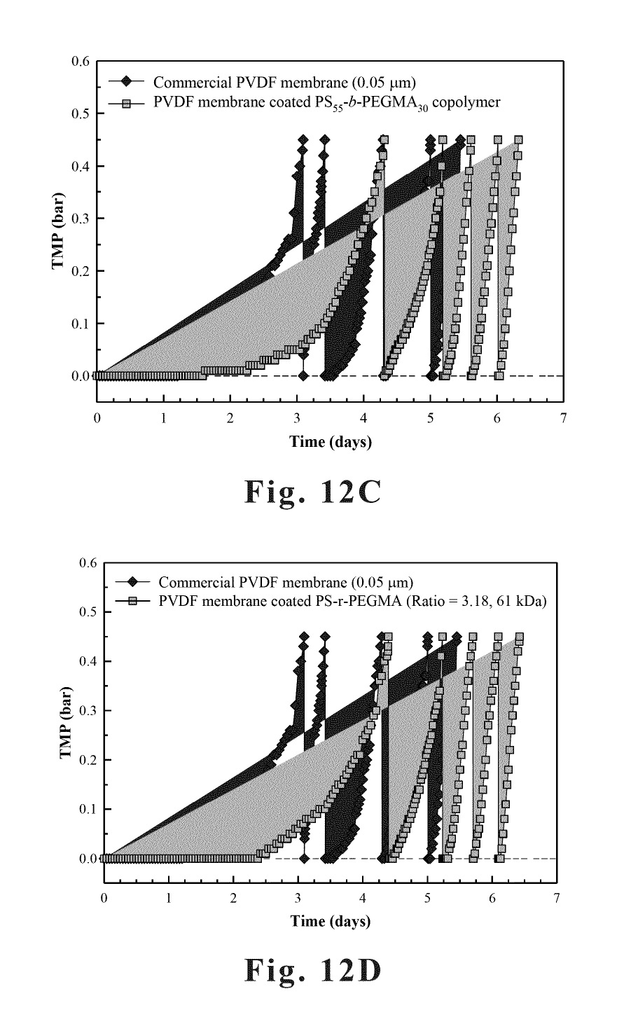

In this example, the fouled level of the membranes is evaluated by measuring the trans-membrane pressure (TMP), and the results are presented in FIG. 12A to FIG. 12D.

Referred to FIG. 12A and FIG. 12B, the measured TMP of the non-coated substrate membrane (PVDF) and the substrate membrane (PVDF) coated with the anti-biofouling copolymer PS₅₅-b-PEGMA₃₀ and the substrate membrane (PVDF) coated with the anti-biofouling copolymer PS₂₄₁-r-PEGMA₇₆ are respectively presented therein. From FIG. 12A and FIG. 12B, it is easily to be found that the non-coated substrate membrane PVDF is not with any anti-biofouling capability, and the measured TMP is rapidly raised to 0.45 bar. After water washed, the non-coated substrate membrane PVDF cannot back to the original TMP. That is, the fouling on the surface of the non-coated substrate membrane PVDF is irreversible. The fouled non-coated substrate membrane PVDF must be washed by chemical washing process to get back the original TMP, and the cost of the membrane cleaning process will be increased. Oppositely, the substrate membrane (PVDF) coated with the anti-biofouling copolymer PS₅₅-b-PEGMA₃₀ and the substrate membrane (PVDF) coated with the anti-biofouling copolymer PS₂₄₁-r-PEGMA₇₆ present excellent anti-fouling capability. The PEGMA hydrophilic portion on the surface of the anti-biofouling membrane coated with the anti-biofouling copolymer PS₅₅-b-PEGMA₃₀ or PS₂₄₁-r-PEGMA₇₆ can interact with water molecules by hydrogen bonding to form a thin water layer for keeping the fouling particles from contacting with the surface of the anti-biofouling membrane. Even the anti-biofouling membrane is fouled, the fouling is reversible. After simply water washed, the TMP of the anti-biofouling membrane coated with the anti-biofouling copolymer PS₅₅-b-PEGMA₃₀ or PS₂₄₁-r-PEGMA₇₆ can get back the original TMP value. After operating multiple cycles, the surface of the mentioned anti-biofouling membrane is still as clean as original one, as shown in FIGS. 12A and 12B. Therefore, the mentioned anti-biofouling membrane coated with the anti-biofouling copolymer PS₅₅-b-PEGMA₃₀ or PS₂₄₁-r-PEGMA₇₆ can provide excellent anti-fouling capability.

Furthermore, FIG. 12C and FIG. 12D respectively presents the measured TMP in the MBR system of a commercial available PVDF membrane and the anti-biofouling membrane coated with the anti-biofouling copolymer PS₅₅-b-PEGMA₃₀ or PS₂₄₁-r-PEGMA₇₆. The commercial available PVDF membrane is from china, and the surface porous diameter is 0.05 μm. According to FIG. 12C and FIG. 12D, it is obviously to find that the anti-biofouling membrane coated with the anti-biofouling copolymer PS₅₅-b-PEGMA₃₀ or PS₂₄₁-r-PEGMA₇₆ of this specification can present as excellent anti-biofouling capability as the commercial membrane on preventing irreversible fouling happened on the surface of the membrane.

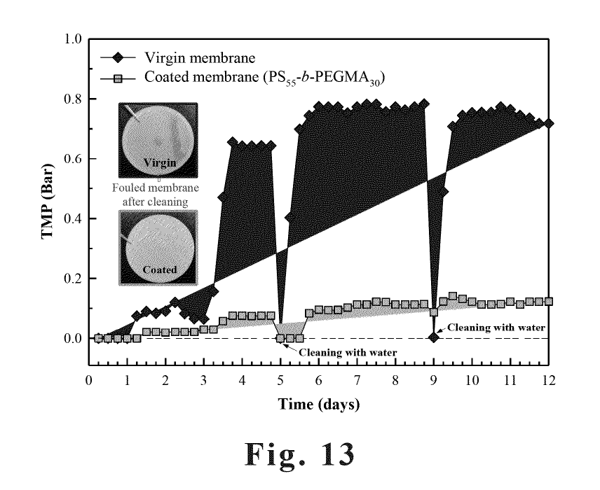

For further evaluating the capability of the anti-biofouling membrane of this specification, a membrane filtration test is performed at the MBR in Tokyo domestic wastewater treatment works. The permeated flux is controlled at about 20 L/m² hr. The measured TMP results are presented as FIG. 13. In this test, it is easily to find that the TMP value of the anti-biofouling membrane according to this invention (PS₅₅-b-PEGMA₃₀) is kept at about 0.16 bar. The TMP value of the non-coated substrate membrane is far larger than the TMP value of the anti-biofouling membrane (PS₅₅-b-PEGMA₃₀). The TMP value of the non-coated substrate membrane is about 4 times to the TMP value of the anti-biofouling membrane (PS₅₅-b-PEGMA₃₀). Therefore, the anti-biofouling membrane can efficiently keep the membrane surface from impurities adsorption and/or adhesion, and the anti-biofouling membrane can perfectly be used in water-treatment.

In summary, this application has reported an anti-biofouling membrane for water-treatment. The mentioned anti-biofouling membrane for water-treatment comprises a substrate, and an anti-biofouling copolymer on the substrate. The substrate can be filtering membrane in water-treatment. The anti-biofouling copolymer can comprise a plurality of first polymer segments with hydrophobic monomer groups and a plurality of second polymer segments with hydrophilic monomer groups. The ratio of the first polymer segments with hydrophobic monomer groups to the second polymer segments with hydrophilic monomer groups of the mentioned anti-biofouling copolymer is about 0.26-8.05. The average molecular weight of the mentioned anti-biofouling copolymer is about 10⁴ Da-5×10⁷ Da. The polymerized form of said anti-biofouling copolymer can be well-defined block copolymer or random copolymer. The anti-biofouling copolymer can be coated on the substrate by hydrophobic physical absorption, and the substrate is modified by the coated anti-biofouling copolymer. The mentioned anti-biofouling membrane can be obtained fastly, simply, and high efficiently. Preferably, the surface morphology will almost not be changed by the coated anti-biofouling copolymer, and the coated anti-biofouling copolymer will not cover the surface pores of the substrate. More preferably, the anti-biofouling membrane coated with the anti-biofouling copolymer can be used for multiple times and renewed by simply water washed. And, the anti-biofouling capability of the anti-biofouling membrane according to this invention is as excellent as the commercial level. More preferably, based on the excellent anti-biofouling capability and high stability, excluding water-treatment, the anti-biofouling membrane according to this specification can also be applied in other separation process, such as the material separation in food industry, oil-water separation in petrochemical industry, body fluid separation (such as hemodialysis) in clinical medicine. Therefore, this invention provides an anti-biofouling membrane with many advantages as saving cost of frequently changing the membrane, saving cost by renewing the membrane with simply water washing, and increasing the filtering performance by keeping the membrane surface from impurities adhesion and/or absorption.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. An anti-biofouling membrane for water-treatment, comprising:
a substrate; and
an anti-biofouling copolymer on said substrate, wherein said anti-biofouling copolymer comprises a plurality of first polymer segments with hydrophobic monomer groups and a plurality of second polymer segments with hydrophilic monomer groups, wherein the molar ratio of the first polymer segments with hydrophobic monomer groups to the second polymer segments with hydrophilic monomer groups is 0.26-8.05, wherein the first polymer segments with hydrophobic monomer group is polymerized from at least two monomers wherein the monomer is selected from one of the group consisting of the following: styrene monomer group family, styrene monomer group substituted with C₁-C₁₈ linear alkyl monomer group, styrene monomer group substituted with C₁-C₁₈ branched alkyl monomer group, styrene monomer group substituted with C₁-C₁₈ acrylamide monomer group, and styrene monomer group substituted with C₁-C₁₈ methacrylamide monomer group, wherein the second polymer segments with hydrophilic monomer group is selected from one of the group consisting of the following: poly(ethylene glycol) methyl ether methacrylate, poly(ethylene glycol) methacrylate, poly(ethylene glycol) methyl ether acrylate, poly(ethylene glycol) acrylate.

2. The anti-biofouling membrane for water-treatment according to claim 1, wherein the polymerized form of said anti-biofouling copolymer is selected from one of the group consisting of the following: diblock copolymer, triblock copolymer, and random copolymer.

3. The anti-biofouling membrane for water-treatment according to claim 1, wherein average molecular weight of the anti-biofouling copolymer is 0.5×10⁴ Da-5×10⁷ Da.

4. The anti-biofouling membrane for water-treatment according to claim 1, wherein the anti-biofouling copolymer is obtained through atom transfer radical polymerization (ATRP), wherein the molar ratio of the first polymer segments with hydrophobic monomer groups to the second polymer segments with hydrophilic monomer groups is 0.26-6.11.

5. The anti-biofouling membrane for water-treatment according to claim 1, wherein the anti-biofouling copolymer is obtained through reversible addition-fragmentation chain transfer polymerization (RAFT), wherein the molar ratio of the first polymer segments with hydrophobic monomer groups to the second polymer segments with hydrophilic monomer groups is 0.26-6.11.

6. The anti-biofouling membrane for water-treatment according to claim 1, wherein the anti-biofouling copolymer is obtained through free-radical polymerization (FRP), wherein the molar ratio of the first polymer segments with hydrophobic monomer groups to the second polymer segments with hydrophilic monomer groups is 0.53-8.05.

7. The anti-biofouling membrane for water-treatment according to claim 1, wherein the C₁-C₁₈ linear alkyl monomer group is selected from one of the group consisting of the following: vinyl propionate, vinyl pivalate, vinyl neodecanoate, vinyl decanoate, vinyl stearate, methyl acrylate, ethyl acrylate, butyl acrylate, hexyl acrylate, lauryl acrylate, octadecyl acrylate, methyl methacrylate, ethyl methacrylate, butyl methacrylate, hexyl methacrylate, lauryl methacrylate, stearyl methacrylate, benzyl methacrylate, wherein the C₁-C₁₈ branched alkyl monomer group is selected from one of the group consisting of the following: tert-butyl acrylate, isobutyl acrylate, 2-ethylhexyl acrylate, isooctyl acrylate, 3,5,5-trimethylhexyl acrylate, isobornyl acrylate, tert-butyl methacrylate, isobutyl methacrylate, 2-ethylhexyl methacrylate, cyclohexyl methacrylate, wherein the C₁-C₁₈ acrylamide monomer group and the C₁-C₁₈ methacrylamide monomer group are selected from one of the group consisting of the following: N-(3-methoxypropyl)acrylamide, N,N-dimethylacrylamide, N-isopropylacrylamide, N-isopropylmethacrylamide, N-(isobutoxymethyl)acrylamide, N-phenylacrylamide, N-diphenylmethylacrylamide.

8. The anti-biofouling membrane for water-treatment according to claim 1, wherein said substrate is selected from one of the group consisting of the following: polyvinylidene fluoride (PVDF), polystyrene (PS), polyethylsulfone (PES), polypropylene (PP), polysulfone (PSf), polytetrafluoroethene (PTFE), polyamide (PA), polyimde (PI), Polyvinyl Chloride (PVC), carbon nano-tube (CNT), and inorganic ceramic membrane.

9. The anti-biofouling membrane for water-treatment according to claim 1, wherein the styrene monomer group family of said first polymer segments with hydrophobic monomer group is selected from one of the group consisting of the following: styrene, Vinyl benzoate, α-Methylstyrene, Methylstyrene, 3-Methylstyrene, 4-Methylstyrene, 1,3-Diisopropenylbenzene, 2,4-Dimethylstyrene, 2,5-Dimethylstyrene, 2,4,6-Trimethylstyrene, 4-tert-Butylstyrene, 4-Vinylanisole, 4-Acetoxystyrene, 4-tert-Butoxystyrene, 3,4-Dimethoxystyrene, 2-Fluorostyrene, 3-Fluorostyrene, 4-Fluorostyrene, 2-(Trifluoromethyl)styrene, 3-(Trifluoromethyl)styrene, 4-(Trifluoromethyl)styrene, 2,6-Difluorostyrene, 2,3,4,4,6-Pentafluorostyrene, 2-Vinylnaphthalene, 4-Vinylbiphenyl, 9-Vinylanthracene, 4-Benzhydrylstyrene, 4-(Diphenylphosphino) styrene, 2-vinyl pyridine, 3-vinyl pyridine, 4-vinyl pyridine, N-Phenylacrylamide, N-Diphenylmethylacrylamide.

10. The anti-biofouling membrane for water-treatment according to claim 1, wherein the average molecular weight of each said hydrophilic monomer group in said second polymer segments is 300˜5000 Da.

11. An anti-biofouling membrane, comprising:
a substrate; and
an anti-biofouling copolymer on said substrate, wherein said anti-biofouling copolymer comprises a plurality of first polymer block segments with hydrophobic monomer groups and a plurality of second polymer block segments with hydrophilic monomer groups, wherein the molar ratio of the first polymer block segments with hydrophobic monomer groups to the second polymer block segments with hydrophilic monomer groups is 0.26-8.05, wherein the first polymer block segments with hydrophobic monomer groups is polymerized from at least two monomers wherein the monomer is selected from one of the group consisting of the following: styrene monomer group family, styrene monomer group substituted with C₁-C₁₈ linear alkyl monomer group, styrene monomer group substituted with C₁-C₁₈ branched alkyl monomer group, styrene monomer group substituted with C₁-C₁₈ acrylamide group, and styrene monomer group substituted with C₁-C₁₈ methacrylamide group, wherein the second polymer block segments with hydrophilic monomer groups is selected from one of the group consisting of the following: poly(ethylene glycol) methyl ether methacrylate, poly(ethylene glycol) methacrylate, poly(ethylene glycol) methyl ether acrylate, poly(ethylene glycol) acrylate, wherein the polymerized form of said copolymer is diblock copolymer or triblock copolymer;
wherein said substrate is a filtering membrane for water-treatment.

12. The anti-biofouling membrane according to claim 11, wherein said anti-biofouling copolymer is obtained through atom transfer radical polymerization (ATRP) by polymerizing said first polymer block segments with hydrophobic monomer groups with said second polymer block segments with hydrophilic monomer groups in the condition with radical initiator and catalyst, wherein said first polymer block segments with hydrophobic monomer group is polymerized from said monomer in the condition with radical initiator and catalyst firstly, and then said first polymer block segments with hydrophobic monomer group subsequently react with said second polymer block segments with hydrophilic monomer groups to produce said anti-biofouling copolymer.

13. The anti-biofouling membrane according to claim 11, wherein said anti-biofouling copolymer is obtained through reversible addition-fragmentation chain transfer polymerization (RAFT) by polymerizing said first polymer block segments with hydrophobic monomer groups with said second polymer block segments with hydrophilic monomer groups in the condition with at least one RAFT reagent.

14. The anti-biofouling membrane according to claim 11, wherein the molar ratio of the first polymer block segments with hydrophobic monomer groups to the second polymer block segments with hydrophilic monomer groups of the anti-biofouling copolymer is 0.26-6.11.

15. The anti-biofouling membrane according to claim 11, wherein average molecular weight of the anti-biofouling copolymer is 0.5×10 kDa-5×10⁴ kDa.

16. The anti-biofouling membrane according to claim 11, wherein the C₁-C₁₈ linear alkyl monomer group is selected from one of the group consisting of the following: vinyl propionate, vinyl pivalate, vinyl neodecanoate, vinyl decanoate, vinyl stearate, methyl acrylate, ethyl acrylate, butyl acrylate, hexyl acrylate, lauryl acrylate, octadecyl acrylate, methyl methacrylate, ethyl methacrylate, butyl methacrylate, hexyl methacrylate, lauryl methacrylate, stearyl methacrylate, benzyl methacrylate, wherein the C₁-C₁₈ branched alkyl monomer group is selected from one of the group consisting of the following: tert-butyl acrylate, isobutyl acrylate, 2-ethylhexyl acrylate, isooctyl acrylate, 3,5,5-trimethylhexyl acrylate, isobornyl acrylate, tert-butyl methacrylate, isobutyl methacrylate, 2-ethylhexyl methacrylate, cyclohexyl methacrylate, wherein the C₁-C₁₈ acrylamide monomer group and the C₁-C₁₈ methacrylamide monomer group are selected from one of the group consisting of the following: N-(3-methoxypropyl)acrylamide, N,N-dimethylacrylamide, N-isopropylacrylamide, N-isopropylmethacrylamide, N-(isobutoxymethyl)acrylamide, N-phenylacrylamide, N-diphenylmethylacrylamide.

17. The anti-biofouling membrane according to claim 11, wherein said substrate is selected from one of the group consisting of the following: polyvinylidene fluoride (PVDF), polystyrene (PS), polyethylsulfone (PES), polypropylene (PP), polysulfone (PSf), polytetrafluoroethene (PTFE), polyamide (PA), polyimde (PI), Polyvinyl Chloride (PVC), carbon nano-tube (CNT), and inorganic ceramic membrane.

18. The anti-biofouling membrane according to claim 11, wherein the average molecular weight of the anti-biofouling copolymer is 10 kDa-105 kDa.

19. The anti-biofouling membrane according to claim 11, wherein the styrene monomer group family of said first polymer segments with hydrophobic monomer group is selected from one of the group consisting of the following: styrene, Vinyl benzoate, α-Methylstyrene, Methylstyrene, 3-Methylstyrene, 4-Methylstyrene, 1,3-Diisopropenylbenzene, 2,4-Dimethylstyrene, 2,5-Dimethylstyrene, 2,4,6-Trimethylstyrene, 4-tert-Butylstyrene, 4-Vinylanisole, 4-Acetoxystyrene, 4-tert-Butoxystyrene, 3,4-Dimethoxystyrene, 2-Fluorostyrene, 3-Fluorostyrene, 4-Fluorostyrene, 2-(Trifluoromethyl)styrene, 3-(Trifluoromethyl)styrene, 4-(Trifluoromethyl)styrene, 2,6-Difluorostyrene, 2,3,4,4,6-Pentafluorostyrene, 2-Vinylnaphthalene, 4-Vinylbiphenyl, 9-Vinylanthracene, 4-Benzhydrylstyrene, 4-(Diphenylphosphino) styrene, 2-vinyl pyridine, 3-vinyl pyridine, 4-vinyl pyridine, N-Phenylacrylamide, N-Diphenylmethylacrylamide.

20. The anti-biofouling membrane for water-treatment according to claim 11, wherein the average molecular weight of each said hydrophilic monomer group in said second polymer segments is 300˜5000 Da.

21. An anti-biofouling membrane, comprising:
a substrate; and
an anti-biofouling copolymer on said substrate, wherein said anti-biofouling copolymer comprises a plurality of first polymer random segments with hydrophobic monomer groups and a plurality of second polymer random segments with hydrophilic monomer groups, wherein the molar ratio of the first polymer random segments with hydrophobic monomer groups to the second polymer random segments with hydrophilic monomer groups is 0.26-8.05, wherein the first polymer random segments with hydrophobic monomer group is polymerized from at least two monomers wherein the monomer is selected from one of the group consisting of the following: the styrene monomer group family, styrene monomer group substituted with C₁-C₁₈ linear alkyl monomer group, styrene monomer group substituted with C₁-C₁₈ branched alkyl monomer group, styrene monomer group substituted with C₁-C₁₈ acrylamide monomer group, and styrene monomer group substituted with C₁-C₁₈ methacrylamide monomer group, wherein the second polymer random segments with hydrophilic monomer groups is selected from one of the monomer group consisting of the following: poly(ethylene glycol) methyl ether methacrylate, poly(ethylene glycol) methacrylate, poly(ethylene glycol) methyl ether acrylate, poly(ethylene glycol) acrylate, wherein the polymerized form of said copolymer is random copolymer;
wherein said substrate is a filtering membrane for water-treatment.

22. The anti-biofouling membrane according to claim 21, wherein said anti-biofouling copolymer is obtained through atom transfer radical polymerization (ATRP) by polymerizing said first polymer random segments with hydrophobic monomer groups with said second polymer random segments with hydrophilic monomer groups in the condition with catalyst and radical initiator, wherein said first polymer random segments with hydrophobic monomer group is polymerized from said monomer in the condition with radical initiator and catalyst firstly, and then said first polymer random segments with hydrophobic monomer group subsequently react with said second polymer random segments with hydrophilic monomer groups to produce said anti-biofouling copolymer.

23. The anti-biofouling membrane according to claim 21, wherein said anti-biofouling copolymer is obtained through reversible addition-fragmentation chain transfer polymerization (RAFT) by polymerizing said first polymer random segments with hydrophobic monomer groups with said second polymer random segments with hydrophilic monomer groups in the condition with at least one RAFT reagent.

24. The anti-biofouling membrane according to claim 21, wherein said anti-biofouling copolymer is obtained through thermal-induced free-radical polymerization (TFRP) by polymerizing said monomer of said first polymer random segments with hydrophobic monomer groups with said second polymer random segments with hydrophilic monomer groups in the condition with radical initiator.

25. The anti-biofouling membrane according to claim 21, wherein the molar ratio of the first polymer random segments with hydrophobic monomer groups to the second polymer random segments with hydrophilic monomer groups of the anti-biofouling copolymer is 0.53-8.05.

26. The anti-biofouling membrane according to claim 21, wherein average molecular weight of the anti-biofouling copolymer is 0.5×10 kDa-5×10⁴ kDa.

27. The anti-biofouling membrane according to claim 21, wherein the C₁-C₁₈ linear alkyl monomer group is selected from one of the group consisting of the following: vinyl propionate, vinyl pivalate, vinyl neodecanoate, vinyl decanoate, vinyl stearate, methyl acrylate, ethyl acrylate, butyl acrylate, hexyl acrylate, lauryl acrylate, octadecyl acrylate, methyl methacrylate, ethyl methacrylate, butyl methacrylate, hexyl methacrylate, lauryl methacrylate, stearyl methacrylate, benzyl methacrylate, wherein the C₁-C₁₈ branched alkyl monomer group is selected from one of the group consisting of the following: tert-butyl acrylate, isobutyl acrylate, 2-ethylhexyl acrylate, isooctyl acrylate, 3,5,5-trimethylhexyl acrylate, isobornyl acrylate, tert-butyl methacrylate, isobutyl methacrylate, 2-ethylhexyl methacrylate, cyclohexyl methacrylate, wherein the C₁-C₁₈ acrylamide monomer group and the C₁-C₁₈ methacrylamide monomer group are selected from one of the group consisting of the following: N-(3-methoxypropyl)acrylamide, N,N-dimethylacrylamide, N-isopropylacrylamide, N-isopropylmethacrylamide, N-(isobutoxymethyl)acrylamide, N-phenylacrylamide, N-diphenylmethylacrylamide.

28. The anti-biofouling membrane according to claim 21, wherein said substrate is selected from one of the group consisting of the following: polyvinylidene fluoride (PVDF), polystyrene (PS), polyethylsulfone (PES), polypropylene (PP), polysulfone (PSf), polytetrafluoroethene (PTFE), polyamide (PA), polyimde (PI), Polyvinyl Chloride (PVC), carbon nano-tube (CNT), and inorganic ceramic membrane.

29. The anti-biofouling membrane according to claim 21, wherein the average molecular weight of the anti-biofouling copolymer is 20 kDa-135 kDa.

30. The anti-biofouling membrane according to claim 21, wherein the styrene monomer group family of said first polymer random segments with hydrophobic monomer group is selected from one of the group consisting of the following: polystyrene, Vinyl benzoate, α-Methylstyrene, Methylstyrene, 3-Methylstyrene, 4-Methylstyrene, 1,3-Diisopropenylbenzene, 2,4-Dimethylstyrene, 2,5-Dimethylstyrene, 2,4,6-Trimethylstyrene, 4-tert-Butylstyrene, 4-Vinylanisole, 4-Acetoxystyrene, 4-tert-Butoxystyrene, 3,4-Dimethoxystyrene, 2-Fluorostyrene, 3-Fluorostyrene, 4-Fluorostyrene, 2-(Trifluoromethyl)styrene, 3-(Trifluoromethyl)styrene, 4-(Trifluoromethyl)styrene, 2,6-Difluorostyrene, 2,3,4,4,6-Pentafluorostyrene, 2-Vinylnaphthalene, 4-Vinylbiphenyl, 9-Vinylanthracene, 4-Benzhydrylstyrene, 4-(Diphenylphosphino) styrene, 2-vinyl pyridine, 3-vinyl pyridine, 4-vinyl pyridine, N-Phenylacrylamide, N-Diphenylmethylacrylamide.

31. The anti-biofouling membrane for water-treatment according to claim 21, wherein the average molecular weight of each said hydrophilic monomer group in said second polymer segments is 300˜5000 Da.
